(19) United States
(12) Patent Application Publication
(10) Pub. No.: US 2019/0173873 A1
(43) Pub. Date: Jun. 6, 2019

(54) IDENTITY VERIFICATION DOCUMENT REQUEST HANDLING UTILIZING A USER CERTIFICATE SYSTEM AND USER IDENTITY DOCUMENT REPOSITORY

(71) Applicant: Averon US, Inc., Henderson, NV (US)

(72) Inventors: Wendell BROWN, Henderson, NV (US); Mark KLEIN, Henderson, NV (US)

(21) Appl. No.: 16/207,907

(22) Filed: Dec. 3, 2018

Related U.S. Application Data
(60) Provisional application No. 62/593,390, filed on Dec. 1, 2017.

(51) Int. Cl. H04L 29/06; G06F 16/93; G06F 16/953; H04L 9/32

(52) U.S. Cl. CPC H04L 63/0823; H04L 9/3268; G06F 16/953; G06F 16/93

(57) ABSTRACT

Systems, methods, apparatuses, and computer readable media for processing an identity-related request on a user certificate system associated with a user identity document repository by storing identity verification documents on a user identity document repository associated with a user certificate system. An exemplary method comprises receiving, from a requesting entity, an identity-related request, retrieving an identity verification document set associated with the identity-related request from a user identity document repository, generating an identity-related response using the retrieved identity verification document set, and transmitting the identity-related response to the requesting entity.

### CROSS-REFERENCE TO RELATED APPLICATIONS

This application claims priority to U.S. Provisional Application No. 62/593,390 filed Dec. 1, 2017, the content of which is incorporated herein by reference in its entirety.

### TECHNOLOGICAL FIELD

Embodiments of the invention relate, generally, to processing identity-related request on a user certificate system associated with a user identity document repository by storing identity verification documents on a user identity document repository associated with a user certificate system, and using Public-Key Interface (“PKI”) certificates linked to information on a user certificate system to convey identity, and more specifically, to linking identity-linked information associated with user device possession attestation, such as a phone number or other device-linked identification number, to certificate information accessible on a user certificate system for use in generating an identity message that may be verified by the service provider to confirm a user identity.

### BACKGROUND

Each HTTPS-enabled service provider has certificates installed on their web servers that identify the service provider to a user and allows the user's web browser to securely communicate with the service provider. However, typically, the service provider does not have reciprocal assurance of the user's identity. To facilitate identification of the user, service providers often perform authentication using a username and password, and in some systems, perform a second factor of authentication, such as a one-time password (“OTP”) over short message service (“SMS”). While conventional transport layer security (“TLS”) protocols have client certificate functionality built in and supported by all major web browsers, the technical expertise required to acquire, install, and manage a client certificate on a web browser, along with the access control required to prevent unauthorized use, has severely limited the adoption of this form of user identification.

The applicant has discovered problems with current systems, methods, and apparatuses and through applied effort, ingenuity, and innovation, Applicant has solved many of these identified problems by developing a solution that is embodied by the present invention, which is described in detail below.

### BRIEF SUMMARY

In general, embodiments of the present invention provided herein include systems, methods, apparatuses, and computer readable media for processing an identity-related request on a user certificate system associated with a user identity document repository by storing identity verification documents on a user identity document repository associated with a user certificate system, such that stored identity verification documents can be retrieved and used to generate an identity-related response.

Other systems, methods, and features will be, or will become, apparent to one with skill in the art upon examination of the following figures and detailed description. It is intended that all such additional systems, methods, features to be included within this description, be within the scope of the disclosure, and be protected by the following claims.

In some embodiments, a method of processing an identity-related request on a user certificate system associated with a user identity document repository may be provided, the method comprising receiving, from a requesting entity, an identity-related request, retrieving an identity verification document set associated with the identity-related request from a user identity document repository, generating an identity-related response using the retrieved identity verification document set, and transmitting the identity-related response to the requesting entity.

In some embodiments of the method, the identity-related request comprises identifier information, and retrieving the identity verification document set comprises querying the user identity document repository for the identity verification document set associated using the identifier information, and receiving a response comprising the identity verification document set.

In some embodiments of the method, retrieving the identity verification document set comprises receiving, over a first network, identification information comprising at least identity-linked information, querying the user identity document repository for the identity verification document set associated using the received identity-linked information, and receiving a response comprising the identity verification document set.

In some embodiments of the method, the method further comprises receiving, over a first network, identification information comprising at least identity-linked information, retrieving certificate information associated with identity-linked information, generating an identity message using the retrieved certificate information, and transmitting, to the requesting entity over a second network, the identity message.

In some embodiments of the method, the generated identity-related response comprises the retrieved identity verification document set.

In some embodiments of the method, the generated identity-related response comprises a portion of a particular identity verification document in the identity verification document set.

In some embodiments of the method, generating the identity-related response using the retrieved identity verification document set comprises performing a document transformation using a particular identity verification document in the identity verification document set, identifying an identity-related determination, and generating the identity-related response comprising the identity-related determination.

In some embodiments of the method, the identity-related request is a request to combine a first identity verification document associated with first identifier information and second identity verification document associated with second identifier information, and retrieving the identity document set comprises retrieving the first identity verification document using the first identifier information, and retrieving the second identity verification document using the second identifier information, and the method further comprises combining the first identity verification document and the second identity verification document to form a combined verification document, and storing the combined verification document in the user identity document repository, wherein the generated identity-related response comprises information indicating successful formation of the combined verification document.

In some embodiments of the method, the identity-related request is a request to cross-check a first identity verification document associated with first identifier information and second identity verification document associated with second identifier information, and retrieving the identity document set comprises retrieving the first identity verification document using the first identifier information, and retrieving the second identity verification document using the second identifier information, and the method further comprises extracting first identification information in the first identity verification document, extracting second identification information in the second identity verification document, and comparing the first identification information with the second identification information to identify an identity-related determination, and the generated identity-related response comprises the identity-related determination.

In some embodiments of the method, the identity-related request is a request to score a first identity verification document associated with first identifier information and second identity verification document associated with second identifier information, and retrieving the identity document set comprises retrieving the first identity verification document using the first identifier information, and retrieving the second identity verification document using the second identifier information, and the method further comprises identifying scoring rules associated with the identity-related request, generating, using the scoring rules, a first document score associated with the first identity verification document, generating, using the scoring rules, a second document score associated with the second identity verification document, and identifying an identity-related determination using the first document score and the second document score, and the generated identity-related response comprises the identity-related determination.

In some embodiments, an apparatus may be provided comprising at least a processor and a memory associated with the processor having computer coded instructions therein, with the computer coded instructions configured to, when executed by the processor, cause the apparatus to receive, from a requesting entity, an identity-related request, retrieve an identity verification document set associated with the identity-related request from a user identity document repository, generate an identity-related response using the retrieved identity verification document set, and transmit the identity-related response to the requesting entity.

In some embodiments of the apparatus, the identity-related request comprises identifier information, and the computer program instructions configured to cause the apparatus to retrieve the identity verification document set comprise computer program instructions configured to, when executed by the processor, cause the apparatus to query the user identity document repository for the identity verification document set associated using the identifier information, and receive a response comprising the identity verification document set.

In some embodiments of the apparatus, the computer program instructions configured to cause the apparatus to retrieve the identity verification document comprises computer program instructions configured to, when executed by the processor, cause the apparatus to receive, over a first network, identification information comprising at least identity-linked information, query the user identity document repository for the identity verification document set associated using the received identity-linked information, and receive a response comprising the identity verification document set.

In some embodiments of the apparatus, the memory further comprises computer coded instructions configured to, when executed by the processor, cause the apparatus to receive, over a first network, identification information comprising at least identity-linked information, retrieve certificate information associated with identity-linked information, generate an identity message using the retrieved certificate information, and transmit, to the requesting entity over a second network, the identity message.

In some embodiments of the apparatus, the generated identity-related response comprises the retrieved identity verification document set.

In some embodiments of the apparatus, the generated identity-related response comprises a portion of a particular identity verification document in the identity verification document set.

In some embodiments of the apparatus, the computer coded instructions configured to cause the apparatus to generate the identity-related response using the retrieved identity verification document set comprises computer coded instructions configured to, when executed by the processor, cause the apparatus to perform a document transformation using a particular identity verification document in the identity verification document set, identify an identity-related determination, and generate the identity-related response comprising the identity-related determination.

In some embodiments of the apparatus, the identity-related request is a request to combine a first identity verification document associated with first identifier information and second identity verification document associated with second identifier information, and the computer coded instructions configured to cause the apparatus to retrieve the identity document set comprises computer coded instructions configured to, when executed by the processor, cause the apparatus to retrieve the first identity verification document using the first identifier information, and retrieve the second identity verification document using the second identifier information, and the memory further comprises computer coded instructions configured to, when executed by the processor, cause the apparatus to combine the first identity verification document and the second identity verification document to form a combined verification document, and store the combined verification document in the user identity document repository, and the generated identity-related response comprises information indicating successful formation of the combined verification document.

In some embodiments of the apparatus, the identity-related request is a request to cross-check a first identity verification document associated with first identifier information and second identity verification document associated with second identifier information, and the computer coded instructions configured to, when executed by the processor, cause the apparatus to retrieve the identity document set comprises computer coded instructions that, when executed by the processor, cause the apparatus to retrieve the first identity verification document using the first identifier information, and retrieve the second identity verification document using the second identifier information, and the memory further comprises computer coded instructions configured to, when executed by the processor, cause the apparatus to extract first identification information in the first identity verification document, extract second identification information in the second identity verification document, and compare the first identification information with the second identification information to identify an identity-related determination, and the generated identity-related response comprises the identity-related determination.

In some embodiments of the apparatus, the identity-related request is a request to score a first identity verification document associated with first identifier information and second identity verification document associated with second identifier information, and the computer coded instructions configured to, when executed by the processor, cause the apparatus to retrieve the identity document set comprises computer coded instructions that, when executed by the processor, cause the apparatus to retrieve the first identity verification document using the first identifier information, and retrieve the second identity verification document using the second identifier information, and the memory further comprises computer coded instructions configured to, when executed by the processor, cause the apparatus to identify scoring rules associated with the identity-related request, generate, using the scoring rules, a first document score associated with the first identity verification document, generate, using the scoring rules, a second document score associated with the second identity verification document, and identify an identity-related determination using the first document score and the second document score, and the generated identity-related response comprises the identity-related determination.

In some embodiments, a computer program product for processing an identity-related request on a user certificate system associated with a user identity document repository may be provided, the computer program product comprising at least one non-transitory computer-readable storage medium having computer executable program code instructions stored therein, the computer-executable program code instructions comprising program code instructions for receiving, from a requesting entity, an identity-related request, retrieving an identity verification document set associated with the identity-related request from a user identity document repository, generating an identity-related response using the retrieved identity verification document set, and transmitting the identity-related response to the requesting entity.

In some embodiments of the computer program product, the identity-related request comprises identifier information, and the program code instructions for retrieving the identity verification document set comprises computer program instructions for querying the user identity document repository for the identity verification document set associated using the identifier information, and receiving a response comprising the identity verification document set.

In some embodiments of the computer program product, the program code instructions for retrieving the identity verification document set comprises program code instructions for receiving, over a first network, identification information comprising at least identity-linked information, querying the user identity document repository for the identity verification document set associated using the received identity-linked information, and receiving a response comprising the identity verification document set.

In some embodiments of the computer program product, the computer program product further comprises program code instructions for receiving, over a first network, identification information comprising at least identity-linked information, retrieving certificate information associated with identity-linked information, generating an identity message using the retrieved certificate information, and transmitting, to the requesting entity over a second network, the identity message.

In some embodiments of the computer program product, the generated identity-related response comprises the retrieved identity verification document set.

In some embodiments of the computer program product, the generated identity-related response comprises a portion of a particular identity verification document in the identity verification document set.

In some embodiments of the computer program product, the program code instructions for generating the identity-related response using the retrieved identity verification document set comprises program code instructions for performing a document transformation using a particular identity verification document in the identity verification document set, identifying an identity-related determination, and generating the identity-related response comprising the identity-related determination.

In some embodiments of the computer program product, the identity-related request is a request to combine a first identity verification document associated with first identifier information and second identity verification document associated with second identifier information, and the program code instructions for retrieving the identity document set comprises program code instructions for retrieving the first identity verification document using the first identifier information, and retrieving the second identity verification document using the second identifier information, and the computer program product further comprises program code instructions for combining the first identity verification document and the second identity verification document to form a combined verification document, and storing the combined verification document in the user identity document repository, and the generated identity-related response comprises information indicating successful formation of the combined verification document.

In some embodiments of the computer program product, the identity-related request is a request to cross-check a first identity verification document associated with first identifier information and second identity verification document associated with second identifier information, and the program code instructions for retrieving the identity document set comprises program code instructions for retrieving the first identity verification document using the first identifier information, and retrieving the second identity verification document using the second identifier information, and the computer program product further comprises program code instructions for extracting first identification information in the first identity verification document, extracting second identification information in the second identity verification document, and comparing the first identification information with the second identification information to identify an identity-related determination, and the generated identity-related response comprises the identity-related determination.

In some embodiments of the computer program product, the identity-related request is a request to score a first identity verification document associated with first identifier information and second identity verification document associated with second identifier information, and the program code instructions for retrieving the identity document set comprises program code instructions for retrieving the first identity verification document using the first identifier information, and retrieving the second identity verification document using the second identifier information, and the computer program product further comprises program code instructions for identifying scoring rules associated with the identity-related request, generating, using the scoring rules, a first document score associated with the first identity verification document, generating, using the scoring rules, a second document score associated with the second identity verification document, and identifying an identity-related determination using the first document score and the second document score, wherein the generated identity-related response comprises the identity-related determination.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example system within which embodiments of the present invention may operate.

FIG. 2 illustrates a block diagram showing an example apparatus for facilitating user identification in accordance with some exemplary embodiments of the present invention.

FIG. 3 illustrates a data flow diagram depicting data flow operations for registering a new user identity with a service provider in accordance with some example systems within which embodiments of the present invention may operate.

FIGS. 4, 5, and 6 illustrate flowcharts depicting example operations for registering a new user identity with a service provider and a user certificate system in accordance with some example embodiments discussed herein.

FIG. 7 illustrates a data flow diagram depicting data flow operations for facilitating user identification in accordance with some example systems within which embodiments of the present invention may operate.

FIGS. 8, 9, and 10 illustrate flowcharts depicting example operations for facilitating user identification in accordance with some example systems within which embodiments of the present invention may operate.

FIG. 11 illustrates another example system within which embodiments of the present invention may operate.

FIG. 12 illustrates a flowchart depicting example operations for processing an identity-related request on a user certificate system associated with a user identity document repository.

### DETAILED DESCRIPTION

Embodiments of the present invention now will be described more fully hereinafter with reference to the accompanying drawings, in which some, but not all, embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data”, “content”, “information”, and similar terms, may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like, sometimes referred to herein as a “network.” Where multiple networks are described, it will be appreciated that each network in the multiple networks may utilize entirely different components, share some components, share all components, and otherwise be configured such that a first network and a second network may be entirely separate networks, partially the same network, or entirely the same network.

### Overview

PKI certificates facilitate user identity authorization by leveraging cryptographic signatures. Messages, requests, data and other information transmitted over a network may be “signed” by a sender with a secret cryptographic key, creating an encrypted data message. The encryption algorithm used to sign the message is often designed such that the encrypted data message may then be decrypted by a second key corresponding to the sender, and only by that second key. If the recipient successfully decrypts the encrypted data, the recipient knows with certainty that the sender is truly who they claim to be, as they would not have been able to create the encrypted message without controlling the secret cryptographic key.

Systems using asymmetric cryptographic algorithms, such as those leveraging PKI, use two keys to perform this verification. The first key is a private key, which remains controlled by the entity to be verified (e.g., a sender of a message). The private key forms a pair with a public key, such that when a message is signed using the private key, it may be decrypted using the public key, and only using the public key. While the private key must remain secret, the public key may be distributed to a recipient such that the recipient may use it verify messages coming from the sender. To facilitate easy transmission and storage, the public key may be stored in a certificate, which may contain other information such as information associated with the certificate holder, information associated with the entity for which the certificate is verifying, a signature chain used to verify the entities issuing the certificate, and the like. Service providers typically store certificates on their servers that may be used to verify to users that the service provider is who they claim to be. However, users typically do not have certificates associated with them that may provide reciprocal confirmation to the service provider that the user is who they claim to be.

However, service providers often have a need to identify a user for the purpose of providing services and/or billing for services. This means service providers often must rely on alternative methods of confirming a user's identity, such as authorization through a username and password. These methods of confirming a user's identity may cause security problems, as storing user credentials for authorization purposes puts the service provider at risk for security breaches that lead to theft of user credentials. Indeed, over the past few years there have been increasing amounts of large-scale thefts of user credentials on the scale of hundreds of millions in the United States alone. Combining this with the fact that many users reuse their credentials across services has led security experts to conclude that credentials alone are no longer a secure way to authenticate users.

Subsequently, service providers may also utilize second-factor authentication schemes, such as OTP over SMS. However, these systems may require technical expertise that makes adoption of a second-factor authentication scheme prohibitive. In some instances, second-factor authentication schemes may have security flaws related with them such that using the authentication method is similarly insufficient. Additionally or alternatively, in instances where a second-factor authentication scheme is utilized, the second-factor authentication scheme may be cumbersome, difficult for users to perform, other otherwise diminish a user's experience with the service provider.

Client certificate functionality is built into the TLS protocol and supported by all major web browsers, but similarly has technical expertise required to acquire, install, and manage a client certificate on a web browser along with the access control required to prevent unauthorized use that has severely limited the adoption of this form of user identification. However, certificates are in common use on many other types of electronic devices, such as cable set-top boxes where they provide positive identification of the device to the cable company. While this use of certificates has put an end to the cloning of set-top boxes and the pirating of cable company content, certificates may be installed and reliably managed on cable set-top boxes because they remain under the control of the cable company. At any given time, the cable company knows which of their subscribers is associated to a specific set-top box. If a set-top box is reported stolen by a subscriber or the subscriber terminates service, the cable company can easily shut down access privileges of that set-top box using the certificate.

Other devices, such as the mobile phone, are conspicuously absent from the types of devices that host certificates. Installing a certificate on a mobile phone, for example, would be of some utility, but it would also be wrought with further problems. For example, while service providers would be able to identify the mobile phone with certainty, if the mobile phone changes hands, such as through sale or theft, the new owner would have access to the certificate of the previous user. Unlike the cable company example, a service provider would not have timely knowledge that a mobile phone's certificate is no longer associated with the user.

However, Applicants have identified that certain information associated with devices may be used as “identity-linked information,” such that the information functions as a proxy for the identity of the device holder. For example, mobile phones have become as ubiquitous as a wallet or purse. Mobile phones are typically kept in close proximity to the user and kept in control of that user. In the event of loss or theft, the mobile phone is typically protected by a numeric passcode, a pattern passcode, a fingerprint or other biometric characteristic of the user, or the like. While the user may change to a new phone in the event of a loss or theft, the user retains their phone number. The certainty of the association between the mobile phone number and the device user's identity relies on the security built into the Subscriber Identity Module (SIM) used by the mobile phone carrier to positively identify the user for billing purposes. When a user replaces a SIM card, they often retain their mobile phone number.

Accordingly, embodiments of the present inventions address these problems by creating certificates and linking the certificates to identity-linked information associated with a user identity or user device, such as a mobile-phone number. The certificate(s) created may contain to certificate information, such as a public key, private key, certificate chain/certificate verification information, which may be used to identify the process used to generate the certificate up to a trusted certificate authority, and/or user information such as a name.

The certificates may be stored by a user certificate system and used to generate an identity message, which may allow the service provider to confirm the user identity. For example, in one embodiment a user may request, using their mobile phone, services from a service provider. During account registration with the service provider, service provider may configure a link that, when accessed on the mobile phone, enables access to identity-linked information, such as the mobile phone number, by the user certificate system. In an exemplary embodiment, the link may cause a mobile phone number to be provided, via a header enrichment process. In particular, a packet header enrichment process, in which packet headers comprise device identification information, includes, for example, packet headers “injected” by a trusted party such as a carrier, network provider or through a login process. For example, in some embodiments, one or more network providers may inject a phone number associated with a mobile device within packet headers. In this manner, the user certificate system or in some embodiments, a third party authentication system, may obtain device identification information without user input. Since the mobile phone is likely secured such that only the rightful user of a device associated with a mobile phone number may access it, a carrier may be sure that when a request is made over a device associated with that mobile phone number, it is truly from the user. Thus, the mobile phone number functions as identity-linked information because it serves as a proxy for the user identity itself.

Continuing the example, a mobile phone number is linked to a certificate at the time of registration such that both a public certificate, including a public key, and a private key may be stored by the user certificate system. For subsequent transactions, an identity message may be generated that verifies the user identity. For example, a user may later request services from a service provider, such as after they registered their account, and the service provider may require authentication. The service provider may configure a link and transmit it to a user device, such that accessing the link will once again cause transmission of identity-linked information to the user certificate system, such as by a carrier through header enrichment. The user certificate system may then retrieve stored certificate information that is linked to the identity-linked information, and use it to generate an identity message. The identity message serves to confirm that the identity associated with the user has been confirmed by the identity-linked information. So, for example, an identity message may be generated that includes an encrypted portion signed using a private key stored on the user certificate system linked to the identity-linked information. When the identity message is transmitted to the service provider, the service provider may then verify the user's identity has been associated with the identity-linked information, such that verification of the identity message serves as a proxy for the user's identity, by decrypting the encrypted portion using a corresponding public key, such as one received during registration. In particular, embodiments described herein may be configured to facilitate user identification to a service provider by linking, on a user certificate system, certificate information with identity-linked information, such as a mobile phone number. In some embodiments, the user certificate system may receive the identity-linked information in response to a request for services, such as a request by a user to sign up for a new account with the service provider or a request by a user to add enhanced authentication to their existing account with the service provider. In some embodiments, the certificate information may comprise public certificate information linked to the identity-linked information, and private information, such as a private key, linked to the identity-linked information. In such embodiments, the public certificate information, comprising, for example, a public key, may be provided to a service provider. The public certificate information may be transmitted to the service provider in the form of a digital certificate, such as a X.509 certificate. In some embodiments, the service provider may then store the digital certificate, or at least the public key, with a user profile associated with the user requesting services. In some embodiments, when the user certificate system receives identity-linked information indicating the user needs to be authenticated in response to a request for services from the service provider, the user certificate system may then retrieve the certificate information linked to the identity-linked information, generate an identity message, and use a portion of the certificate information, such as the private key, to cryptographically sign the identity message and transmit the identity message to the service provider. In some embodiments, the user certificate system may additionally provide the public certificate information or a portion of the public certificate information, for example the public key in the form of a digital certificate, to the service provider. In such embodiments, the service provider may a public key associated with the user requesting services, for example a public key stored in a certificate associated with a user profile that made the request for services or a public key received along with the identity message, to decrypt the identity message. Once the service provider successfully decrypts the message using the public key, the service provider can be certain that the user is who they claim to be.

Other examples of identity-linked information may similarly be used. For example, just as a telephone number may be used as identity-linked information to create and manage corresponding “telephone certificate” information, one or more biometric characteristics may be used as identity-linked information to create and manage corresponding “biometric certificate” information. “Biometric certificate” information may be created upon registration with a user certificate system in a similar manner as described above, and may be certified up to a trusted certificate authority. Similarly, an identity message may be generated when the user certificate system receives matching biometrics as identity-linked information, or otherwise confirms the matching biometrics have been entered into a user device.

Additionally, some embodiment user certificate systems use identity-linked information to create and manage certificate information that may be used to identify a device itself. For example, an Internet of Things (“IoT”) device may be associated with identity-linked information, such that certificate information may be linked to the identity-linked information and used to identify the IoT device, for example by using an identity message as described herein.

The user certificate system may be generalized to store more than just certificate information. For example, a user certificate system may contain a user identity document repository. Alternatively or additionally, a user certificate system may be associated with a user identity document repository such that the user certificate system may access, modify, and/or delete identity verification documents or information from the user identity document repository. A user identity document repository may be configured to store documents, images, information, or the like associated with identity verification documents associated with the user, such as a social security card. One or more identity verification documents may similarly be linked to identity-linked information and stored accordingly, such that the user certificate system may retrieve the documents using received identity-linked information. A user certificate system may utilize a user identity document repository to respond to identity-related requests. For example, a user certificate system may configured to use a user identity document repository perform a document transformation, such as to respond to an identity-related request to confirm a user is above a specified age. Alternatively or additionally, a user certificate system may be configured to use a user identity document repository to access and/or release an identity verification document, or a portion thereof. Alternatively or additionally, a user certificate system may be configured to use a user identity document repository to respond to an identity-related request to cross-check identity verification documents, combine identity verification documents, or score identity verification documents. The user certificate system may perform the above actions utilizing a corresponding user identity document repository module, and/or an associated separate user identity document repository.

### Definitions

A person having ordinary skill in the art would understand a “carrier network” refers to a telecoms network infrastructure provided by a telecoms service provider.

The term “biometric indicator” refers to data representing a biometric feature associated with a user. Examples of a biometric indicator include, but are not limited to, a fingerprint scan, a face scan, an iris scan, and a walking gait.

The term “certificate authority” refers to an entity that issues digital certificates. A digital certificate issued by a certificate authority may include certification information associated with identity attestation information. In some embodiments, a certificate authority may receive a certificate signing request from a user certificate system. In some embodiments, a certificate authority may receive a public key, or a public and private key, associated with the certificate signing request. In some embodiments, a certificate authority may generate the public and private key, and include them in the response to the certificate signing request. Additionally, in some embodiments, a certificate authority may provide a digital signature associated with the certificate authority, such that the digital signature can be used to verify that the digital certificate was issued from the certificate authority. A particular certificate authority may be associated with a particular entity type, such as a commercial entity, government entity, and the like.

A certificate authority may be a “trusted certificate authority” if it is considered trustworthy enough for a system to consider certificates issued by the trusted certificate authority as valid. Each certificate authority may have a level of trust associated with it. Certain certificate authorities may be highly trusted due to their entity type (e.g., government certificate authorities) or due to other factors such as length of operation (e.g., a commercial certificate authority with a long existence may be more trusted than a new commercial certificate authority).

The term “certificate authority verification process” refers to the process a certificate authority utilizes to verify the identity of an entity or person before issuing corresponding certificate information. While a simple verification process may not request any particular identifying information, highly-trusted certificate authorities may require particular verification steps, such as in-person verification, that are highly reliable.

A trusted certificate authority with a highly reliable certificate authority verification process may verify an identity and issue an “ID-VERIFIED certificate”, wherein the ID-VERIFIED certificate is signed by the trusted certificate authority and comprises “ID-VERIFIED information”. The trusted certificate authority issuing the ID-VERIFIED certificate may be trusted sufficiently that parties receiving the ID-VERIFIED certificate it can supplant one or many identification verification documents, which may have been used in the certification authority verification process. For example, a Postal Service may be a certificate authority, and the corresponding verification process may involve an online application and a personal appearance at the post office, where the applicant must produce one or several identity verification documents (e.g., social security card, birth certificate, passport, and the like) to be verified by a Postal Service worker. For a specific example, the verification process may include producing a social security card in an in-person appearance at the post office. Upon completion of this verification process, the Postal Service may issue an ID-VERIFIED certificate, which third-parties and service providers may accept in lieu of a social security card.

The term “certificate information” should be understood to mean information stored in, or associated with, a given certificate. For example, certificate information may include a public key, a portion of a public key, a certificate identifier, identification information, and/or certificate validation information. The term “certificate validation information” would readily be understood to refer to data/information that identifies a certificate authority where the certificate came from, and data/information that can be used to verify that the certificate came from the identified certificate authority. In some example embodiments, the certificate validation information may be “chained” together, such that the generation of the certificate may be validated up to a trusted certificate authority.

The term “device possession confirmation event” refers to receiving information on the user device such that the information received, such as information resulting from a user interaction or received automatically, verifies that the user interacting with the user device is an authenticated user. For example, in some embodiments, a device possession confirmation event may involve receiving, on the user device or another user device, a one-time password sent over SMS to the mobile phone number associated with an authenticated user. Alternatively, a device possession confirmation event may involve receiving, on the user device or another user device, a passcode associated with the user device, a second device, or a dedicated passcode device. In some embodiments, the device possession confirmation event may involve receiving, on the user device or another user device, a biometric indicator (e.g., a retina scan, fingerprint, facial recognition scan, or the like) and matching that biometric indicator with that of the authenticated user. In some embodiments, the device possession confirmation event may cause a service provider to provide information attesting that the user device is associated with an authenticated user (e.g., a mobile carrier attesting that the phone number associated with the user device is controlled by the authenticated user).

The term “document action” refers to any action for managing a collection of documents in a user identification document repository. For example, an example embodiment may support the document actions of (1) adding an identification document to the user identification document repository, (2) deleting the identification document from the user identification document repository, and (3) distributing an identification document from the user identification document repository.

The term “header enrichment” refers to a process for authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, a network 118 may inject a phone number associated with a mobile device within packet headers. In this manner, the authentication system may obtain device identification information without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

One having ordinary skill in the art would recognize that a “hardware security module” (or “HSM”) refers to a software module, hardware module, or physical device that safeguards digital keys. Additionally, a HSM may be configured to generate cryptographic keys. Security in a certificate environment using the Public Key Infrastructure (“PKI”) hinges on the security of private keys corresponding to their respective public counterpart. Accordingly, HSMs are any module designed to store one or more digital keys in a highly secure manner, wherein the digital keys are highly secure both digitally and physically. In an example embodiment, a hardware security module is a software module that securely stores private keys.

The term “identity verification document” refers to any document that can be used to verify an identity of a user/entity, or contains identification information associated with the identity of the user/entity. For example, an identity verification document may include a social security card, birth certificate, driver's license, national identification card, and the like.

The term “identification information” should be understood to refer to information that, alone or in combination with other identification information, identifies a particular user, entity, or device. For example, identity information may include a name, a phone number, a social security number, a birthday, an identification number, or the like. In some embodiments, identification information may be sent from a user device to a user certificate system, or from a service provider to a user certificate system, which may store all or part of the identification information associated with, or as part of, public certificate information.

The term “identity-linked information” refers to any information related to a user device that functions as a proxy for user identification or user device identification if the user device is accessible to a user. For example, in an example embodiment, identity-linked information is a mobile phone number associated with a user device. In some embodiments, identity-linked information is associated with a human user identity. In some embodiments, identity-linked information is associated with a device identity. In some embodiments, identity-linked information is a biometric indicator, including, for example, a fingerprint, iris scan, face scan, walking gait, drawing pattern. In some embodiments, identity-linked information is a device identification number used to uniquely identify the user device. The term “identity message” refers to a message that may be used to authenticate a user identity. In some embodiments, the identity message may comprise an encoded portion, wherein the encoded portion may be encrypted using a private key associated with a certificate linked to the identity-linked information. Accordingly, a service provider or third-party may use a corresponding public key, such as a public key previously stored through a user registration process or a public key included in an unencrypted portion of the identity message, to decrypt the encrypted portion of the identity message. In some example embodiments, the identity message may comprise, additionally or alternatively, a set of identification information associated with the user identity. The public key and/or set of identification information may be sent in the identity message in the form of a certificate, such as a X.509 certificate.

The term “information preparation notification” refers to a transmission or request that is indicative that information has been retrieved for use in an identity message. For example, in some embodiments, a user certificate system may transmit, or cause transmission of, an information preparation notification to a service provider, such that the service provider is notified that the user certificate system has retrieved information linked to previously sent identity-linked information and the user certificate system is prepared to generate and/or transmit an identity message using the retrieved information. In some embodiments, an information preparation notification may be indicate that the identity message is accessible using a session ID. In some example embodiments, a user certificate system may cause transmission, from a user device to a service provider, of an information preparation notification by transmitting, to the user device, a response to an earlier sent request. In some embodiments, the response may comprise the session ID.

The term “ledger” refers to a log of transactions, such as a log of transaction reports, wherein the log of transactions allows auditing by authorized parties. In some embodiments, the ledger may be stored in a transaction database. In an additional embodiment, the ledger may be stored via a blockchain, such that each new transaction reports is appended to the end of the chain.

The term “linking completed notification” refers to a transmission or request that is indicative that user certificate information is accessible using a session ID. In some embodiments, a user certificate system may successfully link user certificate information to be linked with identity-linked information, or cause such information to be linked, and upon successfully linking such information transmit, or cause transmission of, a linking completed notification from a user device to a service provider. In some example embodiments, a user certificate system may cause transmission of a linking completed notification by transmitting, to a user device, a response to an earlier sent request. In some embodiments, the response to the request may comprise a session ID that may be used in accessing the certificate information.

The term “network” refers to one or more servers, relays, routers, network access points, base stations, and/or the like, capable of transmitting information and/or requests between computing devices. For example, in some embodiments, a network may be a mobile carrier network. In another embodiment, a network may refer to a Wi-Fi network, WLAN, LAN, WAN, or the like. In some embodiments, a “first network” and a “second network” may refer to two separate networks. Alternatively, in some embodiments, a “first network” and a “second network” may refer to the same network, such that the first and second networks transmit information over some shared components or all shared components. Further, in some embodiments, a “first network” and a “second network” may be used to indicate that the two networks are out-of-band with respect to one another.

One having ordinary skill in the art would readily recognize the term “out-of-band” refers to a network or data channel that is separate from a primary network or data channel. For example, in some embodiments, a device network may be out-of-band from a communications network. In some embodiments, the device network may be a carrier network while the communications network may be a Wi-Fi or WLAN network.

A “service provider” refers to any entity that provides services to a user via a user device. For example, a service provider may be an online retailer, software as a service provider, other e-commerce business, or the like. A service provider may be associated with “service provider identification information” that uniquely identifies the service provider. For example, service provider identification information may comprise a combination of attributes associated with service provider (e.g., a service provider name, location, or the like) or may comprise an identification number provided by the service provider or generated by the user certificate system. Service provider identification information may be used to associate a particular service provider with a particular user certificate, such that different user certificates may be associated with different service providers.

The term “session ID” should be understood to refer to information that identifies a particular request from a user device. For example, in some embodiments, a user device may receive from a third-party device or system, generate, or otherwise determine a session ID before requesting services from a service provider. In such embodiments, the user device may subsequently forward the session ID to the service provider, such as in the request for services, and forward the session ID to the user certificate system, such as part of a request. In some example embodiments, the service provider may receive from a third-party device or system, generate, or otherwise determine a session ID, which the service provider may subsequently forward to the user device, such as in a response to a request for services, and cause the user device to forward the session ID to the user certificate system, such as by configuring a link that may, upon accessing the link on the user device, cause a request from the user device to the user certificate system that includes at least the session ID. In such embodiments, the service provider already has access to the session ID, the session ID may effectively be forwarded to the user certificate system using the user device. In some embodiments, the user certificate system may receive from a third-party device or system, generate, or otherwise determine a session ID. In such embodiments, the user certificate system may forward the session ID to the user device by including it in a response notification sent to the user device, such as a response to a request received by the user certificate system, and cause the session ID to be sent from the user device to a service provider, such as by causing the user device to include the session ID as part of a completed linking notification or an information preparation notification.

The term “transaction report” should be understood to refer to information that uniquely memorializes a transaction or transmission of data between a first system and a second system. For example, in an example embodiment, a transaction report may be generated that uniquely memorializes a transmission, to a service provider, of a portion of certificate information linked to identity-linked information. In an additional embodiment, a transaction report may be generated that uniquely memorializes transmission of an identity message to a service provider.

The term “user certificate repository” refers to a repository where public user certificates or public user certificate information is stored. In some example embodiments, a user certificate repository may store public certificate information in the form of a X.509 certificate. In some embodiments, a user certificate repository may store user certificates comprising at least a public key. In additional embodiments, a user certificate repository may store a set of user certificates, wherein each user certificate comprises a public key and a set of identification information associated with a user identity linked to the user certificate by identity-linked information. Highly secure information, such as a private key associated with a public key for a given certificate, should be stored in a HSM rather than in the user certificate repository.

The term “user certificate system” refers to a system comprising a hardware security module storing at least a private key associated with a user certificate, and a user certificate repository storing the user certificate. In some example embodiments, the user certificate system may store additional information, such as additional identification information, in the user certificate repository, such as by including the additional identification information in or associated with the user certificate. In another example embodiment, the user certificate system may additionally be configured to access, or may comprise, a user identity document repository.

The term “user device” refers to a device (e.g., a mobile device) configured to interact with a service provider, a user certificate system, and/or other user devices through one or more networks. Examples of a user device may include a laptop, mobile device (e.g., smartphone and other mobile devices), tablet, personal computer, chip embedded card, credit card, debit card, key fob, or the like, or any combination thereof. In an example embodiment, the user device may be configured to request services from a service provider, receive a link in a response from the service provider, transmit a request to a user certificate system by accessing the link, receive a response from the user certificate system, transmit a notification to the service provider of the response from the user certificate system wherein the notification identifies a session ID the service provider can use to access information from the user certificate system. Alternatively, or additionally, the user device may be configured to communicate with another user device, such as to perform a device possession confirmation event and/or to contact the service user certificate system. For example, a first user device (e.g., a laptop) may request services from a service provider from a user profile. In response, the service provider may provide a link to a second user device (e.g., a smartphone) associated with the user profile. The user may then interact with the second user device to access the link and transmit a request to the user certificate system. The second user device may then receive a response from the user certificate system, and notify the first user device to cause a notification from the first user device to the service provider. Additionally, or alternatively, a second device may receive information useful in completing a device possession confirmation event, such as a SMS message comprising a one-time password. Alternatively, the second device may display an interface prompting user interaction to complete a device possession confirmation event, for example an interface configured to receive and verify a biometric indicator matches with a biometric indicator associated with the user identity.

The term “user identification document repository” refers to a hardware or software document repository module associated with the user certificate system. In an example embodiment, the user identification document repository is configured to store identity verification documents (e.g., social security card, birth certificate, national identification card, and the like). In some embodiments, the user certificate system may additionally comprise the user identification document repository. Alternatively, in some embodiments, the user identification document repository is separate from the user certificate system. In some embodiments, a user identification repository is accessed through a third-party, for example an identity verification document management service provider.

The term “identity-related request” refers to information or data requesting an identity verification document, a portion of an identity verification document, confirmation of identification information, confirmation of an identification information check derived using identification information, or performance of an action involving one or more stored identity verification documents. An exemplary identity-related request is an age threshold check, sent to a user identity document repository, requesting confirmation that a particular user is above a specified age. An alternative identity-related request is a request to access one or more identity verification documents. Another example identity-related request is a request to score one or more identity verification documents. Another example identity-related request is a request to cross-check one or more identity verification documents. Another example identity-related request is a request to combine two or more identity verification documents. In some embodiments, an identity-related request includes identifier information used to retrieve corresponding identity verification documents. In some embodiments, the identifier information is identity-linked information and/or a unique document identifier.

The term “identity-related determination” refers to information or data that represents an answer to a received identity-related request. In some embodiments, a user identity document repository identifies an identity-related determination using identity verification documents, or corresponding information, stored in the user identity document repository. For example, exemplary identity-related determinations may be affirmative if a requested age check is confirmed, or negative otherwise. An example identity-related determination includes an identity verification document with a preferred score, for example when two or more identity verification documents are scored. In some embodiments, an identity-related determination indicates whether a particular action associated with an identity-related request was successful. For example, an identity-related determination may indicate a success when an identity-related request to combine identity verification documents was successfully performed. In some embodiments, an identity-related determination is identified based on a comparison of identification information in two or more identity verification documents, such a comparison performed as in response to an identity-related request to cross-check identity verification documents.

The term “document transformation” refers to a process of identifying information from an identification verification document, or a portion of an identification verification document, stored in a user identity document repository and analyzing the identified information to identify an identity-related determination. An example document transformation transforms an identity verification document to identify birthday information for use in an age check. An example document transformation then processes the identified birthday information to identify an identity-related determination, for example an affirmative determination if the user is over a specified age.

The term “identity-related response” refers to information or data sent by a user identity document repository in response to an identity-related request that includes an identity verification document, a portion of an identity verification document, or an identity-related determination. For example, in an example embodiment, a user identity document repository transmits an identity-related response that includes an identity-related determination in response to an earlier received age check request.

### Technical Underpinnings and Implementation of Exemplary Embodiments

A user identity authorization system in accordance with an embodiment of the invention herein facilitates authorization of a user to a service provider by linking identity-linked information with user certificate information, comprising at least a public key and a private key, on a user certificate system. The user certificate system may then utilize at least the private key to generate an identity message that the service provider may validate using the corresponding public key, so as to verify the identity of the user associated with the identity-linked information.

When a user requests services from a service provider they have a user account with, the service provider often has no assurances the user requesting the services is who they claim to be. Conventional systems either rely on storing user credentials, which may be the subject of a security breach, or second-factor authentication methods that may be technically difficult to implement or cumbersome for the user.

Embodiments described herein facilitate authenticating a user requesting services from a service provider by linking identity-linked information with certificate information in a user certificate system. In particular, various embodiments herein are directed to linking, on a user certificate system, identity-linked information with certification information, comprising at least a public key and a private key, in response to a user device requesting services from a service provider, enabling the user certificate system to provide the public key to the service provider. Further in particular, various embodiments enable a user certificate system to retrieve information linked to the identity-linked information, such as the private key, generate an identity message using at least the retrieved information, sign the identity message by encrypting at least a portion of the identity message using the private key, and transmit the identity message to the service provider such that the service provider may verify the identity of the user requesting services by decrypting the encrypted portion of the identity message using the public key.

### System Architecture

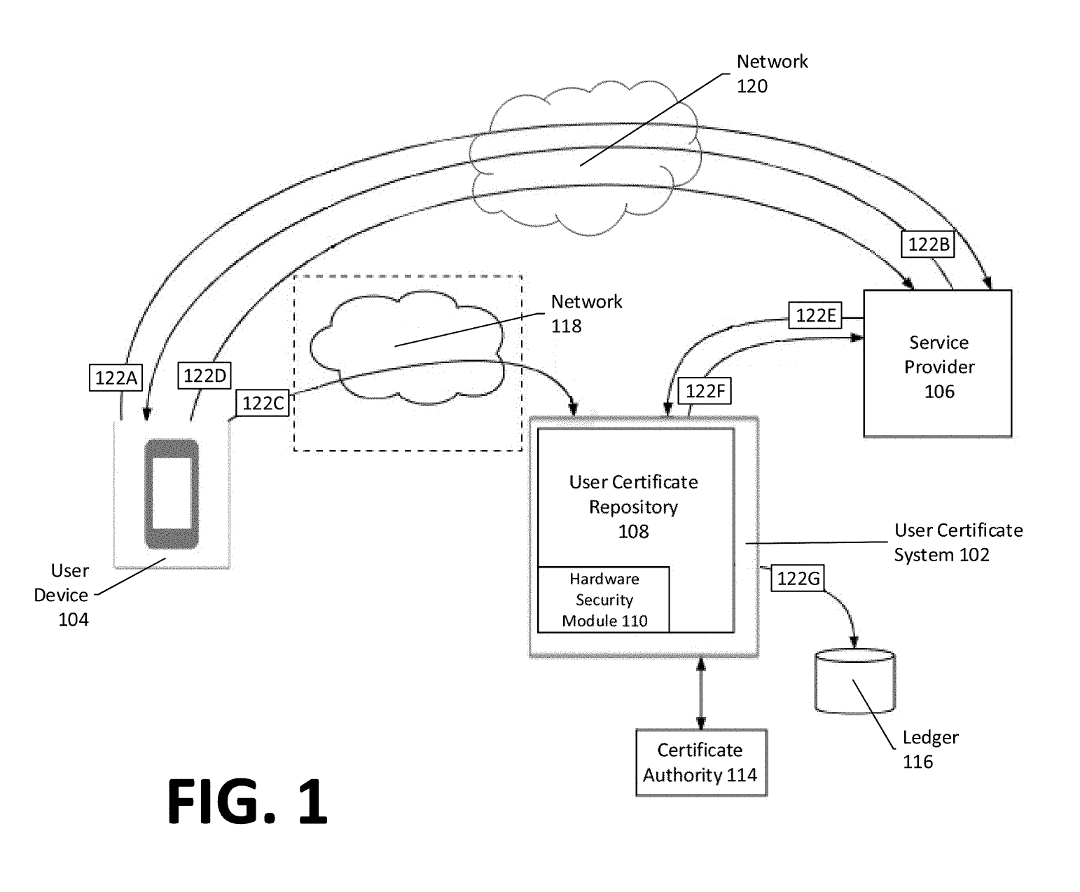

FIG. 1 is a system diagram showing an exemplary system, which may include one or more devices and sub-systems that are configured to implement embodiments discussed herein, and in particular, to implement a user registration process with a user certificate system and user authentication via a user certificate system.

Turning to the FIG. 1, the system may include a user device 104, service provider 106, and user certificate system 102. User certificate system 102, user device 104, and service provider 106, may include any suitable network server and/or other type of processing device to communicate with other devices via one or more networks, such as user device 104, service provider 106, and certificate authority 114.

User device 104 may be configured to communicate with service provider 106 over a network, such as network 120, which may be the Internet or the like. User device 104 may be configured to communicate with user certificate system 102 over a network, such as network 118. Network 118 may be the same as network 120. Alternatively, network 118 may be a network out-of-band with respect to network 120, so as to enhance security by preventing device-based and channel-based cyber-attacks.

In some embodiments, user device 104 may be a smartphone, mobile device, tablet device, kiosk device, or other electronic device. In some embodiments, user device 104 may include one or more sensors configured to detect, identify, or receive a biometric trait. For example, in an exemplary system, user device 104 may be a smartphone with a hardware configured to perform a fingerprint scan or a facial recognition scan.

In some embodiments, user certificate system 102 may be configured to communicate with certificate authority 114. Certificate authority 114 may be configured to generate certificate information, such as a public key and a private key, and transmit it to user certificate system 102. In some embodiments, user certificate system 102 may include processing devices configured to generate certificate information. User certificate system 102 may also be configured to link the certificate information to identity-linked information, such as identity-linked information received over network 118 from user device 104.

User certificate system 102 may include, for example, user certificate repository 108 and hardware security module 110. User certificate system 102 may be configured to store public user certificate information, such as, for example, public key(s), certificate validation information, and the like, in user certificate repository 108. In some embodiments, user certificate repository 108 may additionally store user information, such as a name, birthday, and the like, associated with identity-linked information. User certificate system 102 may be configured to store private certificate information, such as a private key, in hardware security module 110.

In some embodiments, user certificate system 102 may be configured to store information in ledger 116. In some embodiments, user certificate system 102 may include ledger 116, and user certificate system 102 may be configured to include transaction reports in ledger 116. In some embodiments, ledger 116 may be a list, database of records, or other implementation to facilitate tracking a list of transactions. In some embodiments, ledger 116 may comprise a blockchain implementation, wherein the user certificate system 102 may be configured to append transaction reports to the blockchain or submit transaction reports to be appended to the blockchain.

In some embodiments, the components illustrated and described above may be configured to implement multiple operations in accordance with example embodiments of the present invention. For example, the user device 104 may be configured to request services from service provider 106, receive a link from service provider 106, access the link, cause transmission of identity-linked information to user certificate system 102, receive a notification from user certificate system 102, and notify service provider 106. User certificate system 102 may be configured to receive identity-linked information, such as from a carrier using header enrichment over network 118, cause generation of a user certificate and linking with identity-linked information, generate an identity message using certificate information, notify service provider 106 of a completed action, such as through notifying user device 104, and provide information, such as a certificate or identity message, to service provider 106.

In some embodiments, the several components may be configured to communicate in the manner illustrated by blocks 122A-122G. In some embodiments, the user device 104 may transmit a request 122A to service provider 106 over a first network 120. Request 122A may be a request for services, such as to register a new user account, enhance authentication associated with a user account, or the like. In response to the request, service provider 106 may transmit a response 122B. The response 122B may include a link, such as a GET link or other HTTP or HTTPS link. The link may be configured such that accessing the link on the user device transmits identification information 122C from the user device 104 to the user certificate system 102 over a second network 118. In an example embodiment, network 118 may be an out-of-band network with respect to network 120, for example network 120 may be an Internet network and network 118 may be a carrier network. In such an embodiment, facilitating transmission 122C over an out-of-band network prevents device-based and channel-based cyber-attacks. In some embodiments, network 118 and network 120 may be partially or entirely the same network.

In some embodiments, transmission 122C may comprise identity-linked information, such as, for example, a mobile phone number associated with user device 104. In some embodiments, transmission 122C may have identity-linked information added to it by a third-party after the user device begins the transmission, such as by a mobile carrier using header enrichment.

In some embodiments, user certificate system may be configured to, in response to receiving transmission 122C, perform an action for preparing data on the user certificate system 102 in preparation for a request from service provider 106. User device 104 may then transmit notification 122D to service provider 106. In some embodiments, notification 122D may be indicative that user device 104 successfully completed transmission 122C to user certificate system 102, or may be indicative that user device 104 received a response from user certificate system 102 in response to transmission 122C, such that.

In some embodiments, service provider 106 may be configured to, in response to receiving notification 122D, transmit request 122E to user certificate system 102. In some embodiments, request 122E may request certificate information associated with from user certificate system 102. In other embodiments, request 122E may request an identity message from user certificate system 102. In response to receiving request 122E, the user certificate system 102 may be configured to prepare certificate information, such as public certificate information including a public key, for transmission to service provider 106.

The user certificate system then may transmit information 122F to service provider 106. In some embodiments, information 122F may include certificate information linked with the identity-linked information. In such embodiments, service provider 106 may be configured to store information 122F, or a portion thereof, associated with a user profile/user account. In some embodiments, after transmitting information 122F to service provider 106, user certificate system 102 may be configured to store a transaction report 122G in ledger 116. In such embodiments, the transaction report may uniquely identify the transmission of information 122F from user certificate system 102 to service provider 106.

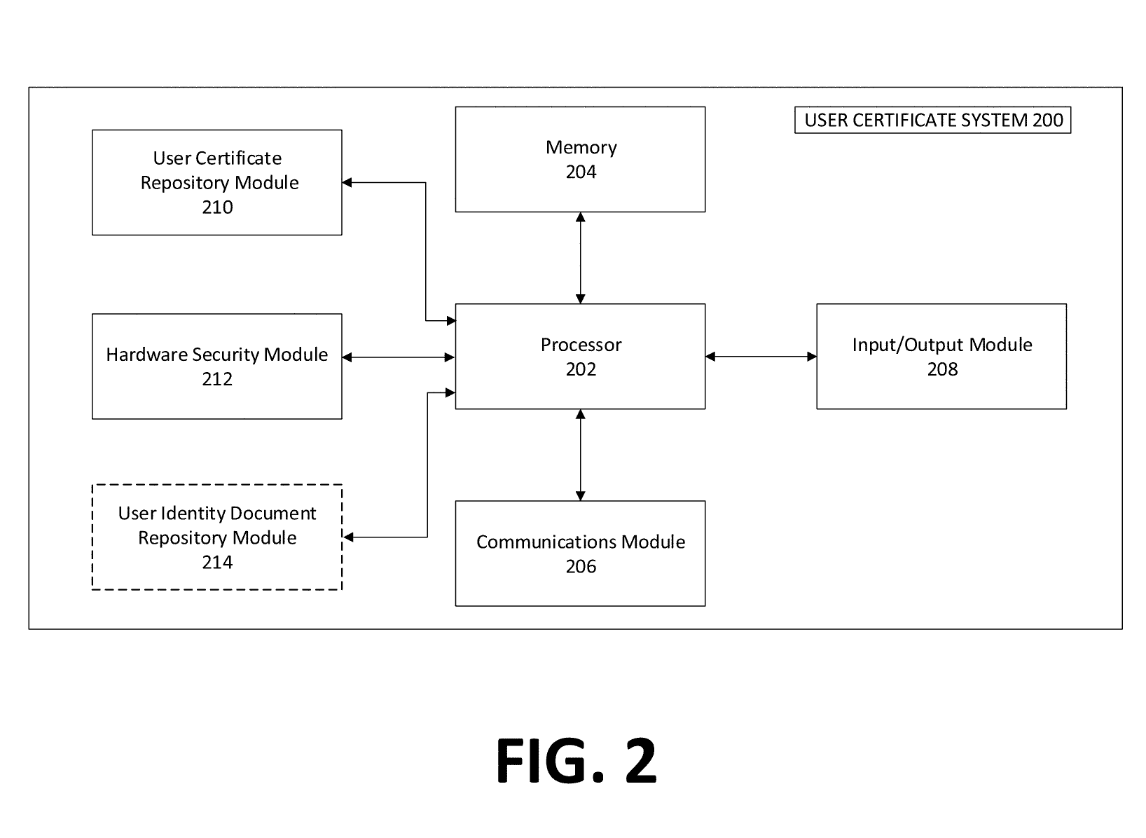

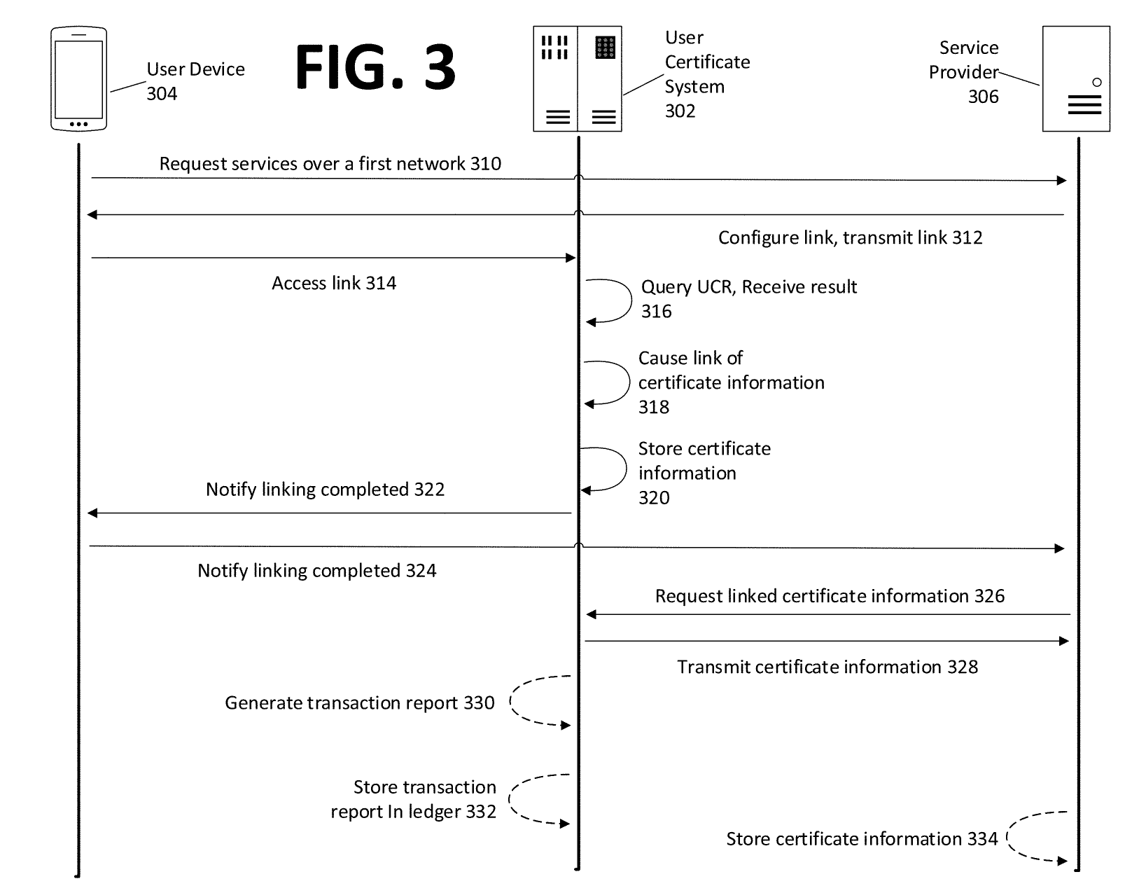

User certificate system 102 may be embodied by one or more computing systems, such as apparatus 200 shown in FIG. 2. As illustrated in FIG. 2, the apparatus 200 may include a processor 202, a memory 204, a communications module 206, input/output module 208, a user certificate repository module 210, and a hardware security module 212. Additionally, in some embodiments, the apparatus 200 may additionally include a user identity document repository module 214. The apparatus 200 may be configured to execute the operations described above with respect to FIG. 1, and below with respect to FIGS. 3-10. Although these components 202-214 are described with respect to functional limitations, it should be understood that particular implementations necessarily include the use of particular hardware. It should also be understood that certain of these components 202-216 may include similar or common hardware. For example, two sets of circuitry may both leverage use of the same processor, network interface, storage medium, or the like to perform their associated functions, such that duplicate hardware is not required for each module. The use of the term “module” as used herein with respect to components of the apparatus should therefore be understood to include particular hardware configured to perform the functions associated with the particular module as described herein.

The term “module” should be understood broadly to include hardware and, in some embodiments, software for configuring the hardware. For example, in some embodiments, “module” may include processing circuitry, storage medium, network interfaces, input/output devices, and the like. In some embodiments, other elements of the apparatus 200 may provide or supplement the functionality of a particular module, or particular modules. For example, the processor 202 may provide processing functionality, the memory 204 may provide storage functionality, the communications module 206 may provide network interface functionality, and the like.

In some embodiments, the processor 202 (and/or co-processor and any other processing module assisting or otherwise associated with the processor) may be in communications with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multithreading. The use of the term “processing module” may be understood to include a single core processor, a multi-core processor, multiple processors internal to the apparatus, and/or remote or “cloud” processors.

In an example embodiment, the processor 20 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 208 that may, in turn, be in communication with processor 202 to provide output to the user and, in some embodiments, to receive an indication of a user input. The input/output module 208 may comprise a user interface and may include a display and may comprise a web user interface, a mobile application, a client device, a kiosk, or the like. In some embodiments, the input/output module 208 may also include a keyboard, a mouse, a touch screen, touch areas, soft keys, a microphone, a speaker, or other input/output mechanisms. The processor and/or user interface module comprising the processor may be configured to control one or more functions of one or more user interface elements through computer program instructions (e.g., software and/or firmware) stored on a memory accessible to the processor (e.g., memory 204, and/or the like).

The communications module 206 may be any means such as a device or circuitry embodied in either hardware or a combination of hardware and software that is configured to receive and/or transmit data from/to a network and/or any other device, circuitry, or module in communication with the apparatus 200. In regard, the communications module 206 may include, for example, a network interface for enabling communications with a wired or wireless communication network. For example, the communications module 206 may include one or more network interface cards, antennae, buses, switches, routers, modems, and supporting hardware and/or software, or any other device suitable for enabling communications via a network. Additionally or alternatively, the communications interface may include the circuitry for interacting with the antenna(s) to cause transmission of signals via the antenna(s) or to handle receipt of signals received via the antenna(s).

User certificate repository module 210 includes hardware and software configured to facilitate storage of public certificate information linked to identity-linked information. Additionally or alternatively, user certificate repository module 210 may be configured to store additional information, such as user information associated with a user identity, linked to identity-linked information. User certificate repository module 210 may be configured to store information in one or more data formats, such as X.509 format. User certificate repository module 210 may receive information via a network interface provided by the communications module 206. However, it should also be appreciated that, in some embodiments, the user certificate repository module 210 may include a separate processor, specially configured field programmable gate array (FPGA), or application specific interface circuit (ASIC) to perform the reception of information to be stored in the user certificate repository module 210. User certificate repository module 210 is therefore implemented using hardware components of the apparatus configured by either hardware or software for implementing these planned functions.

Hardware security module 212 includes hardware and software configured to facilitate storage, safeguarding, and management of digital keys linked to identity-linked information. Additionally or alternatively, hardware security module 212 may be configured to store a private key linked to identity-linked information. Hardware security module 212 may receive information via a network interface provided by the communications module 206. However, it should also be appreciated that, in some embodiments, the hardware security module 212 may include a separate processor, specially configured field programmable gate array (FPGA), or application specific interface circuit (ASIC) to perform the reception of information to be stored in the hardware security module 212. Hardware security module 212 is therefore implemented using hardware components of the apparatus configured by either hardware or software for implementing these planned functions.

In some embodiments, a user certificate system such as apparatus 200 may include a user identity document repository module 214. User identity document repository module 214 includes hardware and software configured to facilitate storage of identity verification documents, images of identity verification documents, and/or other files representing identity verification documents. Identity verification documents, corresponding information associated with identity verification documents, and/or other files representing identity verification documents, such as images, may be stored in the user identity document repository module 214 linked to identity-linked information. Additionally or alternatively, user identity document repository module 214 may be configured to add, delete, or release stored identity verification documents, images of identity verification documents, and/or other files representing identity verification documents to third-parties. Additionally or alternatively, in some embodiments, user identity document repository module 214 may be configured to allow a user to selectively release a portion of one or more identity verification documents. In some embodiments, user identity document repository module 214 may be configured to perform a document transformation using an identity document, or a portion of an identity verification documents, to identify an identity-related determination for use in responding to an identity-related request.

In some embodiments, the user identity document repository module 214 may be configured to receive an identity-related request. Additionally or alternatively, in some embodiments, user identity document repository module 214 may be configured to identify or receive an identity-related determination. In some embodiments, the user identity document repository module 214 may be configured to transmit an identity-related response that includes an identity-related determination. such as to a service provider or third-party system. In some embodiments, user identity document repository module 214 is additionally configured to receive information, from a service provider, third-party device, or the like, for use in identifying an identity-related determination. For example, a particular user identity document repository module 214 may receive an identity-related request that includes identity-linked information, which may be used to retrieve one or more identity verification documents, e.g. an identity verification document set, that includes information useful in identifying an identity-linked determination. In some embodiments, user identity document repository module 214 may be configured to retrieve verification documents linked to the identity-linked information, and perform a document transformation in response to the identity-related request. Alternatively or additionally, in an example embodiment, user identity document repository module 214 is configured to receive threshold information from a service provider, third-party device, or the like, for use in identifying an identity-related determination, for example a specified age associated with an age check. Alternatively or additionally, in some embodiments, user identity document repository module 214, or an associated module, is configured to determine threshold information for use in identifying an identity-related determination, for example a specified age associated with an age check.

In some embodiments, user identity document repository module 214 is configured to release a portion of a stored identity verification document. For example, in some embodiments, user identity document repository module 214 is configured to release a portion of an identity verification document that includes information useful in identifying an identity-related determination. In some embodiments, user identity document repository module 214 may release a portion of an identity verification document in response to receiving an identity-linked request.

In some embodiments, user identity document repository module 214 may be configured to perform the above actions at the time of an initial service request made by a user device. In some embodiments, user identity document repository module 214 may be pre-configured to perform the above actions before a service request made by a user device.

Additionally or alternatively, in some embodiments user identity document repository module 214 is configured to perform one or more operations involving multiple identity verification documents. In an example embodiment, user identity document repository module 214 is configured to combine one or more stored identity verification documents to create a new identity verification document. For example, a service provider may transmit an identity-related request to combine two or more identity verification documents into a combined identity verification document. In some embodiments, the combined identity verification document is included in an identity-related response. In an example identity-related request, identifier information is included for all documents to be combined.

In another example embodiment, user identity document repository module 214 is configured to cross-check one or more stored identity verification documents. For example, user identity document repository module 214 may be configured to compare information between two forms of identification stored as identity verification documents. For example, a service provider may transmit an identity-related request to cross-check two or more identity verification documents. In some embodiments, user identity document repository module 214 is configured to extract first identification information, such as birthdate or name information, in a first identity verification document, extract second identification information in a second identity verification document, and compare the first identification information to the second identification information to identify a result, such as an identity-related determination, that indicates whether the information matches. After the comparison, in some embodiments, the identity-related determination is included in an identity-related response. In an example identity-related request, identifier information is included for all documents to be cross-checked.

Alternatively or additionally, in some embodiments, user identity document repository module 214 may be configured to associate a score with one or more identity verification documents. For example, in an example embodiment, scoring rules may be identified as included as part of an identity-related request for scoring one or more stored identity verification documents, such that the scoring rules are received from a service provider or third party. In some embodiments, the user identity document repository module 214 is configured to identify the scoring rules itself, such as by applying a pre-determined process for scoring identity verification documents. Accordingly, an example user identity document repository module 214 may be configured to release an identity verification document, such as to a requesting service provider, using the document score associated with the identity verification document. As an example case, a service provider may transmit an identity-related request to score one or more identity verification documents, and an identity-related determination may be identified using the score, for example by including the identity verification document with a preferable document score. Accordingly, in some embodiments, the identity-related determination, which may include the identity verification document with the preferable document score, is included in an identity-related response. In an example identity-related request, identifier information is included for all documents to be scored.

User identity document repository module 214 may receive information, documents, or other data for storage and/or use via a network interface provided by the communications module 206. However, it should also be appreciated that, in some embodiments, the user identity document repository module 214 may include a separate processor, specially configured field programmable gate array (FPGA), or application specific interface circuit (ASIC) to perform the reception of information to be stored in the user identity document repository module 214. User identity document repository module 214 is therefore implemented using hardware components of the apparatus configured by either hardware or software for implementing these planned functions.

As will be appreciated, any such computer program instructions and/or other type of code may be loaded onto a computer, processor, or other programmable apparatus' circuitry to produce a machine, such that the computer, processor other programmable circuitry that execute the code on the machine created the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Operations for Implementing Embodiments of the Present Invention

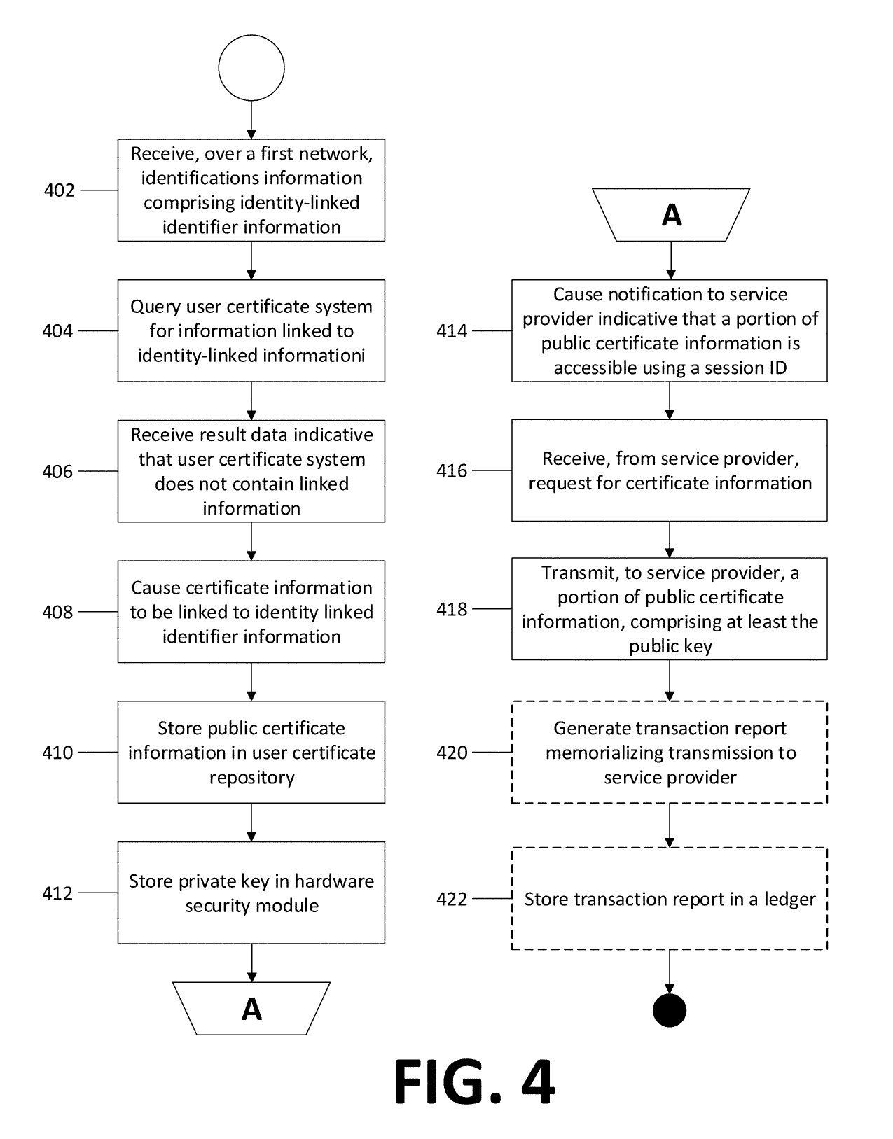

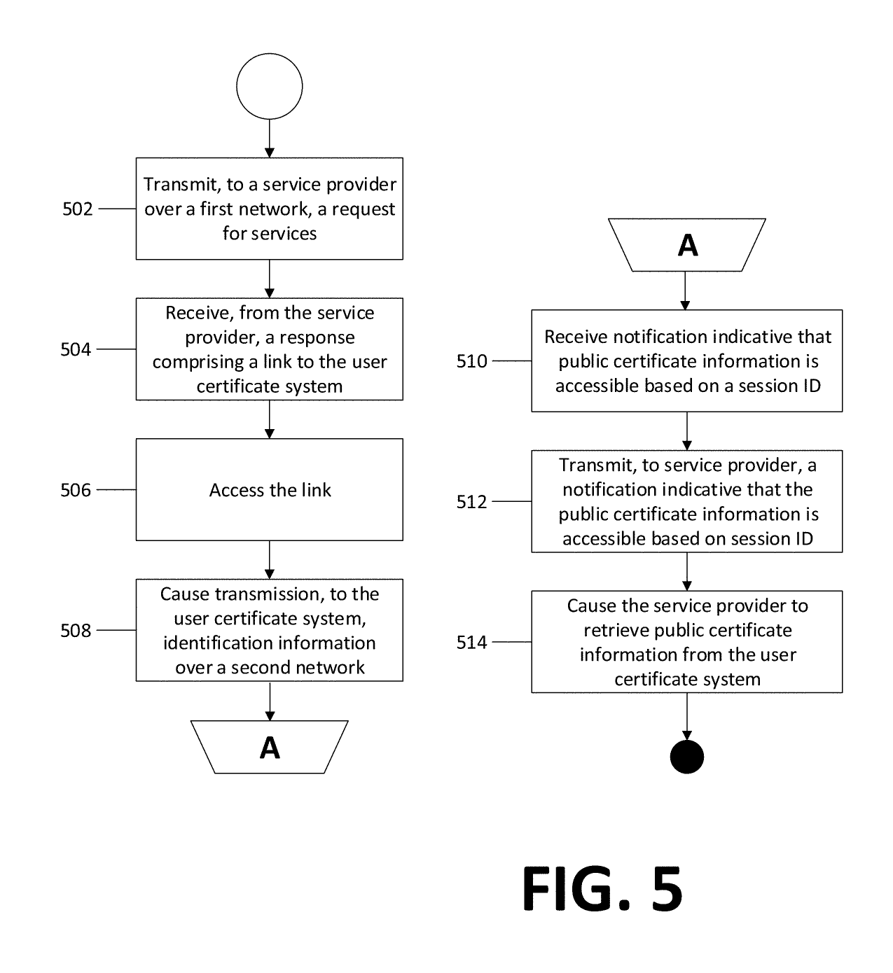

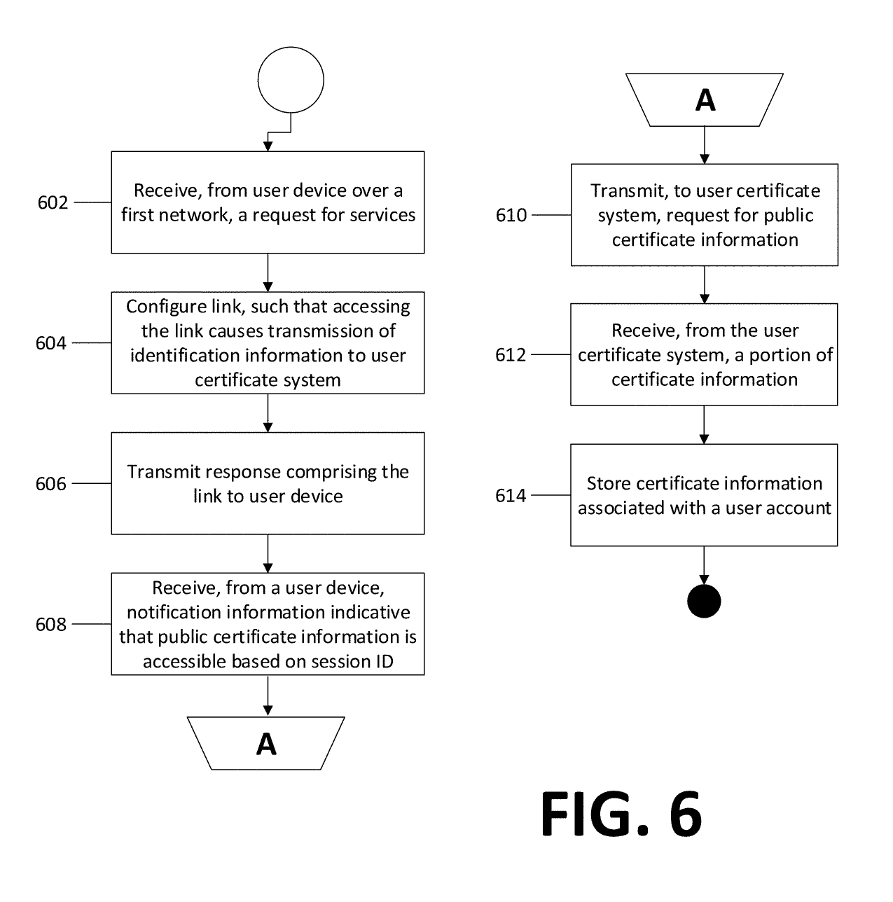

In some embodiments, the system may be configured to implement a user registration process, such that the user registration process registers a user identity with a user certificate system using identity-linked information, and registers the user identity with a user account associated with a service provider by providing certificate information, such as public certificate information comprising a public key, to the service provider. In some embodiments, the system may be configured for facilitating, to a service provider, authentication of a user identity associated with a user device by receiving, on a user certificate system, identification information including identity-linked information and transmitting, from a user certificate system to the service provider, an identity message comprising an encrypted portion signed using a private key linked with the identity-linked information such that the identity message may be validated using a corresponding public key. FIG. 3 illustrates a data flow diagram depicting data flow operations for a registration process, the registration process linking, on a user certificate system, certificate information with identity-linked information, and transmitting certificate information to a service provider, such as for storage associated with a user account. FIG. 4 illustrates flowcharts depicting example operations for a registration process, such as the registration process illustrated by FIG. 3, from the perspective of a user certificate system, such as user certificate system 302. FIG. 5 illustrates flowcharts depicting example operations for a registration process, such as the registration process illustrated by FIG. 3, from the perspective of a user device, such as the user device 304. FIG. 6 illustrates flowcharts depicting example operations for a registration process, such as the registration process illustrated by FIG. 3, from the perspective of a service provider, such as the service provider 306.

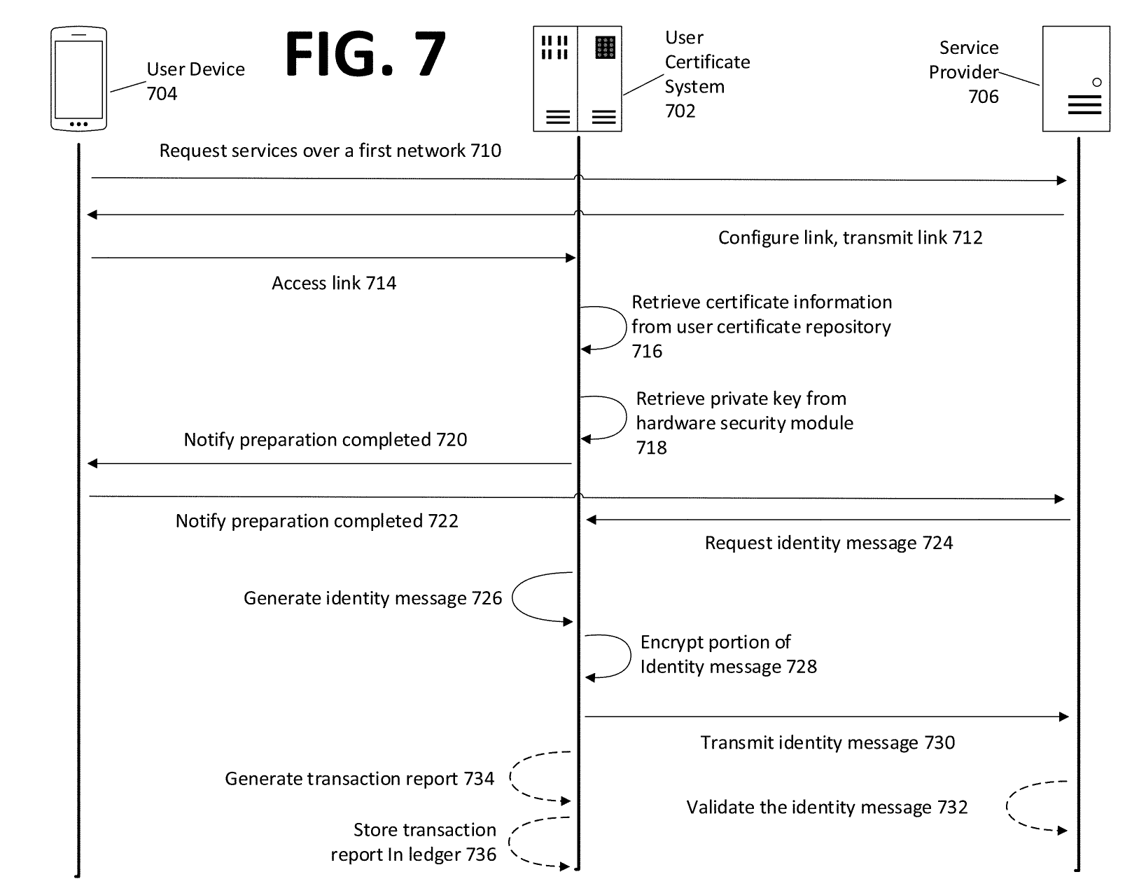

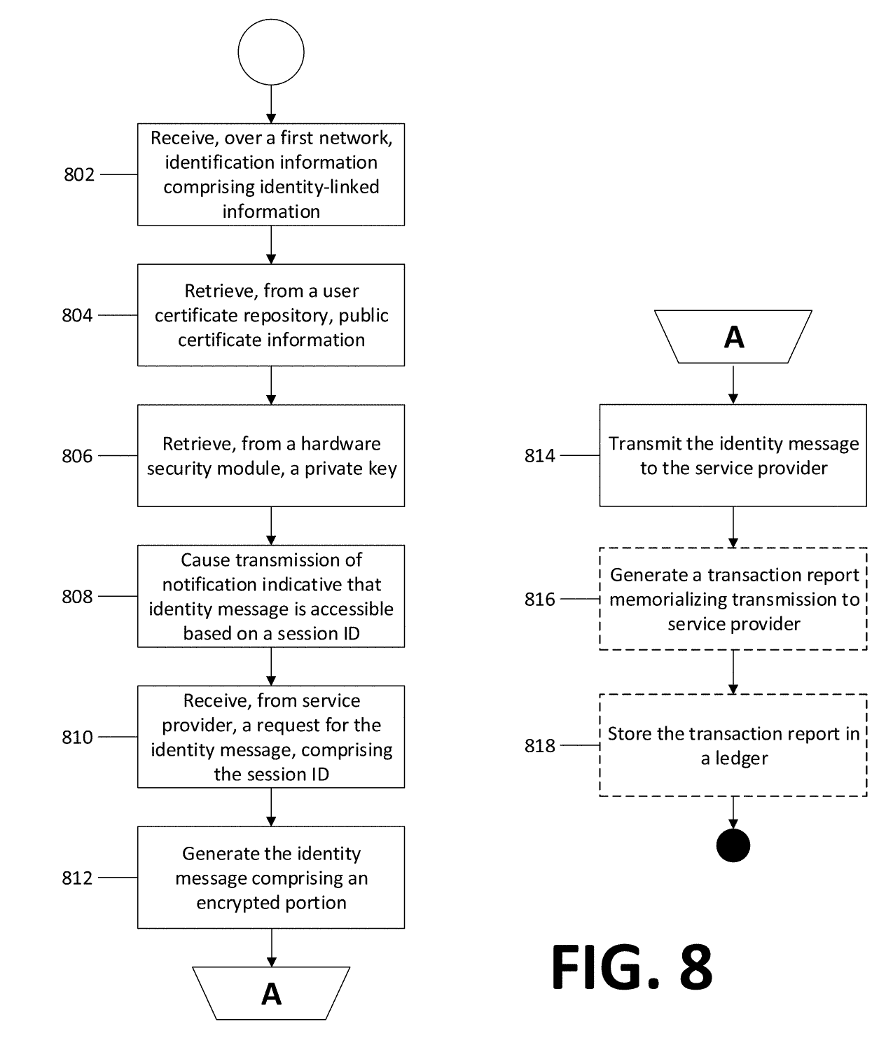

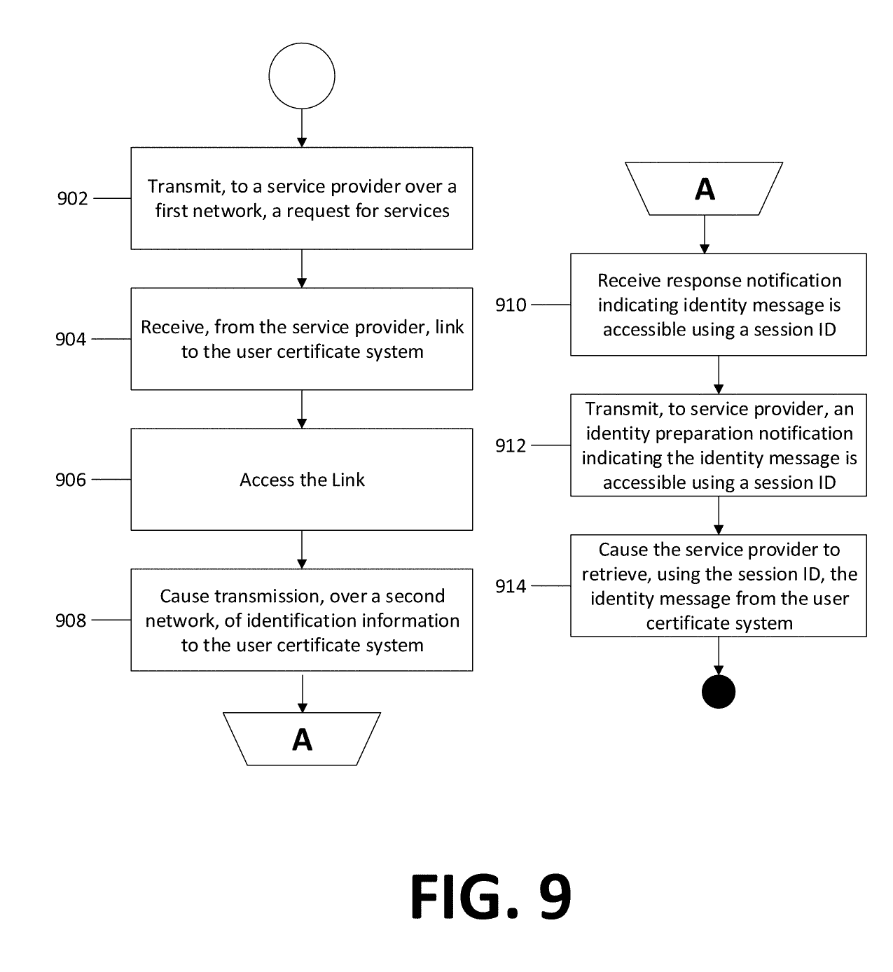

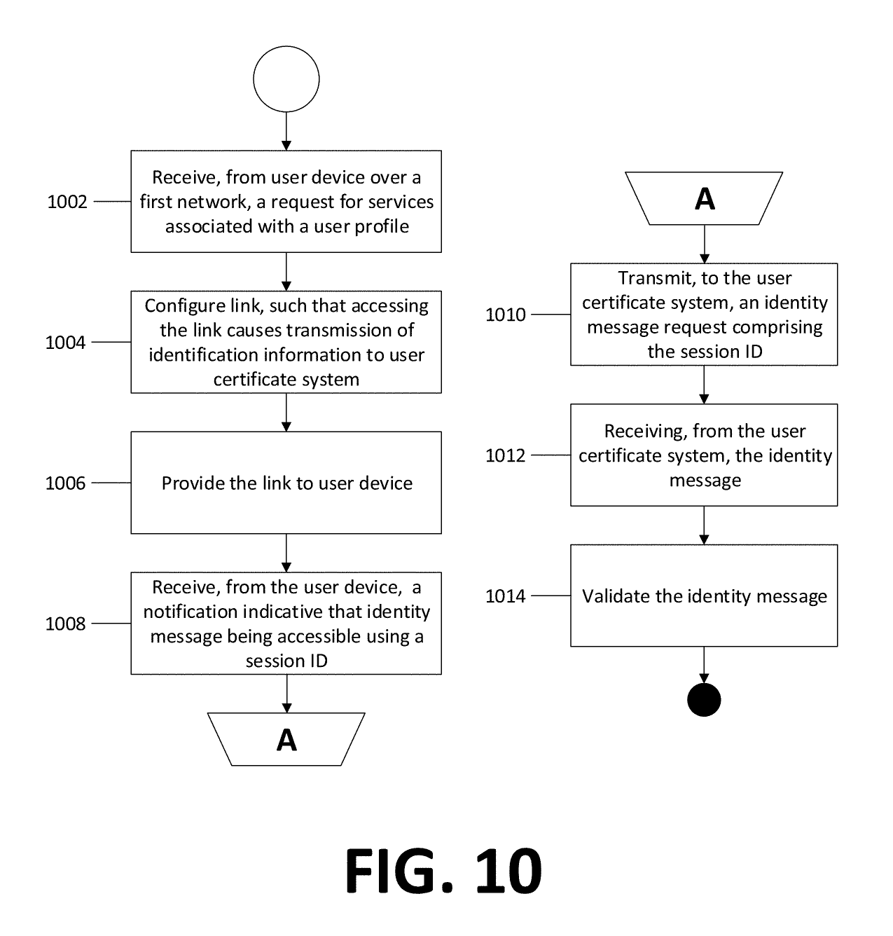

FIG. 7 illustrates a data flow diagram depicting data flow operations for a user identification process, the user identification process retrieving, on a user certificate system, certificate information, comprising at least public certificate information and a private key, with identity-linked information, generating, on a user certificate system, an identity message comprising an encoded portion encrypted using at least the private key, and transmitting the identity message to a service provider, such that the service provider may validate the identity message using a public key associated with the private key. FIG. 8 illustrates flowcharts depicting example operations for a user identification process, such as the user identification process illustrated in FIG. 7, from the perspective of a user certificate system, such as user certificate system 702. FIG. 9 illustrates flowcharts depicting example operations for a user identification process, such as the user identification process illustrated in FIG. 7, from the perspective of a user device, such as the user device 704. FIG. 10 illustrates flowcharts depicting example operations for a user identification process, such as the user identification process illustrated in FIG. 7, from the perspective of a service provider, such as the service provider 706.

### Linking Identity-Linked Information with Certificate Information During User Registration

FIG. 3 illustrates a data flow diagram depicting data flow operations for a registration process, the registration process comprising receiving, on a user certificate system 302, identity-linked information, linking certificate information with identity-linked information associated with a user device 304, and transmitting the certificate information to a service provider 306, such as for storage associated with a user account.

At 310, user device 304 requests services from service provider 306. The requests for services may include, for example, a request to register a new account with service provider 306 or a request to enhance authentication to an existing user profile associated with a user account with service provider 306. In some embodiments, the request made at 310 may additionally include a session ID generated by the user device 304 or received by the user device 304 from a third-party device, system, or component. At 312, in response to receiving the request for services 310, service provider 306 may configure a link to access user certificate system 302, and transmit the link to user device 304. In some embodiments, the link may be configured to transmit information to user certificate system 302, such as identification information including identity-linked information. In some embodiments, the link may be configured to additionally transmit a session ID generated by the service provider 306 or received by the service provider 306 from a third-party device, system, or component and transmitted to the user device at step 312. In some embodiments, the link may be provided to user device 304 through SMS. In some embodiments, the link may be provided to user device 304 along with a local device message, for example an operating system message or application message, which may also query the for confirmation.

At 314, user device 304 may access the link configured and transmitted in 312. In some embodiments, the user device 304 may access the link in response to user engagement with the link, and provide identification information to the user certificate system 302. In some embodiments, the user device 304 may access the link via a redirect or redirects, such as HTTP redirects.

In some embodiments, in response to accessing the link at 314, the user device 304 may cause transmission of identification information to user certificate system 302. In some embodiments, the user device 304 may identification information, such as include identity-linked information, in a transmission at step 314. Alternatively or additionally, a third-party, such as, for example, a mobile carrier (not shown) may include identification information in as transmission to user certificate system 302, such as identity-linked information, for example a mobile phone number, through header enrichment.

After receiving the identification information comprising at least the identity-linked information, the user certificate system 302 may prepare certificate information for access, such as through steps 316-320. At 316, the user certificate system may query for information stored on the user certificate system 302 that is linked to identity-linked information, and receive a result indicative of a determination that the user certificate system does not contain information linked to the identity-linked information. At 318, user certificate system 302 causes certificate information to be linked to the identity-linked information. In some embodiments, the certificate information may comprise public certificate information, which may comprise at least public key. Additionally or alternatively, in some embodiments, the certificate information may comprise private certificate information, which may comprise at least a private key. In some embodiments, the user certificate system 302 may be configured to generate the certificate information. In some embodiments, the user certificate system 302 may be configured to cause a certificate authority to generate certificate information, and the user certificate system 302 may be configured to receive the certificate information from the certificate information from the certificate authority. At 320, the user certificate system 302 may link the certificate information with the identity-linked information and store the certificate information. In some embodiments, the user certificate system 302 may store the public certificate information comprising at least a public key associated with the identity-linked information in a user certificate repository, and may store the private certificate information comprising at least a private key associated with the identity-linked information in a hardware security module.

In some embodiments, a user may request services from a first user device, such as a laptop, associated with a second user device, such as a mobile phone, that may be used for linking user certificate information to identity-linked information. In an example embodiment, a device possession confirmation event may be used to confirm a user's possession of the second user device. In an example embodiment, the device possession confirmation event may be a message, such as a SMS message, sent to the second user device containing the configured link. In some alternative embodiments, other methods may be employed to link a user identity, or a device they possess, to the certificate information. In some embodiments, these methods may include sending a one-time password over SMS to a user device, entering a code on a user device from a device or application running the time-based one-time password algorithm, entering a code on a user device from a device or application running the HMAC-based one-time password algorithm, such as Google Authenticator or Authy Authenticator, using a FIDO key on a user device, entering a biometric indicator (e.g., a fingerprint scan, face scan, iris scan, walking gait) on a user device, drawing a pattern on a user device, or other methods.

At 322, the user certificate system 302 may transmit, to user device 304, a notification indicative of at least a portion of the public certificate information being accessible using a session ID. At 324, in response to receiving the notification transmitted at 322, user device 304 may similarly transmit, to service provider 306, a notification indicative of at least a portion of the public certificate information being accessible using a session ID.

At 326, in response to receiving the notification at 324, service provider 306 may transmit, to the user certificate system 302, a request for the prepared certificate information linked to the earlier sent identity-linked information, the request comprising at least the session ID. At 328, the user certificate system 302 may transmit, to the service provider 306, at least a portion of the public certificate information linked to the identity-linked information, wherein the portion of the certificate information comprises at least the public key.

In some embodiments, the service provider 306 may receive certificate information comprising at least the public key and store the received certificate information at 334. In some embodiments, the service provider 306 may store the received certificate information associated with a user profile used to make the request for services from the user device in 310. In such embodiments, the service provider may utilize the stored certificate information comprising at least the public key to decrypt a portion of an identity message to verify a user identity.

In some embodiments, at 330, the user certificate system 302 may be further configured to generate a transaction report. In such embodiments, the transaction report may uniquely memorialize the transmission of the portion of certificate information from the user certificate system 302 to service provider 306. At 332, in some embodiments, the user certificate system 302 may be configured to store the transaction report generated in 330 in a ledger. In some embodiments, the ledger may be a blockchain associated with the user certificate system 302 such that the user certificate system 302 may append new transaction reports to the blockchain.

FIGS. 4, 5, and 6 illustrate an exemplary set of operations performed in accordance with an embodiment of the present invention. Specifically, each of the FIGS. 4, 5, and 6 illustrates an exemplary set of operations performed by one of user device 304, user certificate system 302, or service provider 306, such as an embodiment system functioning as shown in FIG. 1 and described in FIG. 3.

Turning now to FIG. 4, which illustrates a set of operations performed by a user certificate system, such as a user certificate system 302, in accordance with an exemplary embodiment of the present invention. At block 402, the user certificate system receives, over a first network, identification information comprising at least identity-linked information over a first network. In some embodiments, the identity-linked information may include a phone number in plain-text, a phone number in hashed form, a device-linked identifier, a credit card number, or the like. In some embodiments, the identification information may comprise additional information useful for identifying the user or preparing data, such as a session ID, a name or other identifying information, or the like. In some exemplary embodiments, the user certificate system may receive information in block 402 over a first network that is separate, in whole or in part, with respect to a second network, so as to enhance security. For example, in some embodiments, a user device may request services from a service provider and receive a link configured to transmit identification information to a user certificate system. Block 402 may be performed in response to user interaction with a link provided to a user device over a first network, such as a carrier network, that is separate from a second network, such as the Internet, that the user device utilized to make the original request from the service provider.

Having received the identity-linked information, the user certificate system, in block 404, queries for information linked with the identity-linked information. In some embodiments, the user certificate system may query a user certificate repository for public certificate information linked with the identity-linked information, the hardware security module for information linked with the identity-linked information, another system for information linked with the identity-linked information, or a combination thereof. In some embodiments, such as when a user signs up for a new account with a service provider or when the user adds enhanced authentication to an existing account with a service provider, the user certificate system may not have previously linked information with the identity-linked information, and thus may then, in block 406, receive result data indicative that the user certificate system does not contain information linked to the identity-linked information.

Accordingly, in some embodiments, at block 408 the user certificate system may then cause certificate information to be linked to the identity-linked information.

In some embodiments, the certificate information comprises at least a public key and a private key. Additionally or alternatively, the certificate information may comprise public certificate information, including a public key, and/or private certificate information, including a private key. In some embodiments, the private key and public key should be configured such that messages encrypted using one of the keys may be decrypted using the other key. In some embodiments, a user certificate system may be configured to generate certificate information linked to the identity-linked information at block 408. Alternatively or additionally, a user certificate system may be configured to request certificate information linked to the identity-linked information from a certificate authority, and receive such certificate information as a response from the certificate authority. In some embodiments, the user certificate system may be configured to receive certificate validation information. For example, if a user certificate system requests certificate information from a certificate authority, the certificate authority may include in a response the certificate information and certificate validation information that may be used to verify the certificate information up to a trusted certificate authority. In some embodiments, a trusted certificate authority may be an intermediate certificate authority. In some embodiments, a trusted certificate authority may be a root certificate authority, such that there is certificate authority above the root certificate authority in a certificate validation information certificate chain.

Furthermore, in some embodiments the user certificate system may receive an ID-VERIFIED certificate from a trusted certificate authority, such as a government certificate authority. In such embodiments, the government certificate authority may be controlled by a government entity. These certificate authorities may be highly trusted by implementing a highly reliable certificate authority verification process. A high reliable certificate authority verification process may involve several highly reliable identity verification steps, such as in person appearances and/or providing government documentation. For example, a government postal service may issue ID-VERIFIED certificates after a process involving in-person appearances in which a user presents identification documents for verification. In such embodiments, the ID-VERIFIED certificate information may include additional information, such as the types of identification used in the verification process. The user certificate system may store a portion or all of this information as public certificate information as described herein.

At block 410, the user certificate system may be configured to store public certificate information from the generated certificate information in a user certificate repository. In some embodiments, a user certificate system may store public certificate information in a certificate format, such as a X.509 certificate. In some embodiments, the user certificate system stores the public certificate information in the user certificate repository associated with the identity-linked information such that the public certificate information may be retrieved from the user certificate repository using the identity-linked information.

At block 412, the user certificate system may be configured to store the private key in a hardware security module. In some embodiments, the private key may be stored associated with the identity-linked information such that the private key may be retrieved from the hardware security module using the identity-linked information. In some embodiments, the hardware security module may store private keys in an encrypted format. In some embodiments, the user certificate system may use a portion of the identification information, such as a received history or secret key, to encrypt the private key before storing it.

At block 414, the user certificate system may cause transmission, to a service provider, of a notification indicative that a portion of the linked certificate information is accessible using a session ID. In some embodiments, the user certificate system may cause a user device to transmit a notification to the service provider by transmitting a response message to a user device upon completion of storing the certificate information. In some embodiments, the user certificate system may cause the user device to transmit a notification to the service provider by transmitting a response to the user device upon receipt of the identification information at block 402.

In some embodiments, the user certificate system may cause the notification sent to the service provider to include a session ID. In some embodiments, the session ID may have been generated by the user certificate system in an earlier action, such as blocks 404-412 as depicted in FIG. 4. Alternatively or additionally, in some embodiments the session ID may be received or generated by another system, such as the user device, and transmitted to the user certificate system, such as part of the identification information received at block 402.

At block 416, the user certificate system may receive, from a service provider, a request for a portion of certificate information. In some embodiments, a user device may have requested to register a user account with the service provider, or enhance authorization with an already existing account associated with the service provider. In some embodiments, the user certificate system may receive the request for certificate information from the service provider in response to the service provider receiving the notification transmitted to the service provider in block 414. In some embodiments, the request from the service provider may comprise at least a session ID to be used in receiving the certificate information.

At block 418, the user certificate system transmits, to the service provider, the certificate information comprising at least the public key, which may then be stored by the service provider. In some embodiments, the user certificate system may utilize a session ID, such as a session ID received at block 418, to determine a portion of certificate information should be transmitted to the service provider submitting the request. In some embodiments, the information transmitted to the service provider may be in certificate format, such as X.509 certificate format.

In some embodiments, at optional block 420, the user certificate system may generate a transaction report memorializing the transmission of the certificate information to service provider, such as the transmission at block 418. In some embodiments, the transaction report may comprise information that uniquely identifies the transmission of the portion of certificate information from the user certificate system to the service provider.

In some embodiments, at optional block 422, the user certificate system may store the transaction report generated in block 420 in a ledger. In some embodiments, the user certificate system may maintain a ledger in a list, database, or other component associated with the user certificate system. Alternatively, the user certificate system may be configured to store the transaction report in a blockchain associated with the user certificate system.

Turning now to FIG. 5, which illustrates a set of operations performed by a user device, such as a user device 304, in accordance with an exemplary embodiment of the present invention.

At block 502, the user device transmits, to a service provider over a first network, a request for services. In some embodiments, the request for services may include a request to register a new user account with the service provider, or a request to enhance authentication associated with an existing user account with the service provider.

At block 504, the user device receives, from the service provider, a response comprising at least a link configured to cause transmission of information to a user certificate system upon accessing the link. In some embodiments, the response received at block 504 may additionally comprise a session ID generated or received by the service provider from a third-party system. In some embodiments, the response may be a SMS sent to a device associated with the request to the service provider made in block 502. In some embodiments, the response may be a local device message displayed on the user device.

At block 506, the user device accesses the link provided at block 504. In some embodiments, the user device may be configured to access the link in response to user engagement with the user device, a display associated with the user device, or the like. Additionally or alternatively, the user device may be configured to access the link automatically, for example by using a redirect or redirects, such as HTTP redirects.

At block 508, the user device transmits, to the user certificate system, identification information via a second network. In some embodiments, transmission of the identification information may cause the user certificate system to link certificate information to identity-linked information transmitted to the user certificate system. In some embodiments, the user certificate information may comprise identity-linked information. In some embodiments, the identification information may have identity-linked information included by a third-party, such as a carrier using a process such as header enrichment. In some embodiments, the identification information may include a session ID, such as a session ID generated by the user device in an earlier step, such as blocks 502-506 as depicted in FIG. 5, received by the user device from a third-party system before beginning the steps depicted in FIG. 5, or received from a service provider, such as part of the response from the service provider in block 504.

At block 510, the user device may receive, from the user certificate system, a response notification. In some embodiments, the response notification may be indicative that at least a portion of the information linked to the identity-linked information is accessible based on a session ID. In some embodiments, the session ID may have been transmitted to the user certificate system at block 508 as described above. Alternatively or additionally, the session ID may be generated by the user certificate system and included in the response at block 510.

At block 512, in response to receiving the notification at block 510, the user device may transmit, to the service provider, a notification indicative that at least a portion of the certificate information linked to the identity-linked information, such as public certificate information, is accessible based on a session ID. In some embodiments, the user device may include the session ID in the notification to the service provider so the service provider may later provide it to the user certificate system to access the certificate information.

At block 514, the user device may cause the service provider to retrieve at least a portion of the public certificate information from the user certificate system. In some embodiments, block 514 may occur simultaneously with block 512, such that transmission of the notification to the service provider causes the service provider to retrieve the portion of the public certificate information.

Turning now to FIG. 6, which illustrates a set of operations performed by a service provider, such as a service provider 306, in accordance with an exemplary embodiment of the present invention.

At block 602, the service provider receives, over a first network, a request for services. In some embodiments, the request for services may comprise a request to create a new user account with the service provider or enhance security to a previously existing user account with the service provider. In some embodiments, the request for services may be associated with a user account, such as a new user account to be registered with the service provider or a previously existing user account.

At block 604, the service provider may configure a link such that accessing the link will cause transmission of identification information to the user certificate system. In some embodiments, the link may be configured such that it may be included in a response to a user device.

In some embodiments, the service provider may be configured to generate a session ID. Alternatively or additionally, in some embodiments, the service provider may be configured to receive a session ID from a third-party system. In such embodiments, the service provider may be configured to generate or receive the session ID during, before, or after any of the steps illustrated by blocks 602 and 604.

At block 606, the service provider may transmit a response comprising the link to a user device. In some embodiments, the response may further comprise additional information, such as the session ID generated or received by the service provider. In some embodiments, the service provider may transmit the response at block 606 to a second user device, such that the second user device is separate from, but associated, with the user device that sent the request for services at block 602. For example, in an exemplary embodiment, the service provider may be configured to receive the request for services from a first user device, such as a laptop computer, determine a second device associated with the first user device or the user account, for example a mobile device, and transmit the response at block 606 to the second user device.

At block 608, the service provider may receive, from a user device, information indicative that a portion of public certificate information is accessible on the user certificate system based on a session ID. In some embodiments, the information received at block 608 may be notification information sent from a user device to the service provider after the user device transmitted identification information to the user certificate system over a second network, such as in block 512 depicted in FIG. 5.

At block 610, the service provider may transmit to the user certificate system, a request for at least a portion of the public certificate information. In some embodiments, the request transmitted at block 610 may comprise additional information, such as a session ID.

At block 612, the service provider may receive, from the user certificate system, a response comprising at least certificate information, such a portion of public certificate information. In some embodiments, the response information may comprise at least a public key. In some embodiments, the certificate information included in the response may be formatted in X.509 format.

At block 614, the service provider may store the response certificate information associated with a user account. In some embodiments, the service provider may store the response certificate information associated with information identifying a user account, such that the certificate information may be retrieved using the user account identifying information. In such embodiments, the service provider may retrieve the stored certificate information, or a portion of the stored certificate information, associated with a user account for use in validating an identity message in subsequent identity authorization processes, such as those described in FIGS. 7, 8, 9, and 10.

### Transmitting Identity Messages to Verify Users Registered with the User Certificate System

FIG. 7 illustrates a data flow diagram depicting data flow operations for facilitating a user identification process, the identification process comprising receiving, on a user certificate system 702, identification information comprising identity-linked information, retrieving certificate information linked with the identity-linked information, configuring an identity message comprising an encoded portion that may be used to verify the identity message, and transmitting the identity message to a service provider 706 for verification.

At 710, user device 704 requests services from service provider 706. In some embodiments, the request may include, for example, a request to access a service offered by the service provider 706. In some embodiments, the request may provide a user account registered with the service provider 706 associated with the request for services. In some embodiments, the request may comprise additional information, such as a session ID. At 712, in response to receiving to receiving the request for services at step 710, services provider 706 may configure a link to access user certificate system 702, and transmit the link to user device 704. In some embodiments, the link may be provided to user device 704 through SMS. In some embodiments, the link may be provided to user device 704 through a local device message. In some embodiments, user device 704 may comprise a first user device and a second device, wherein the first user device may transmit the request for services over a first network at step 710, and the service provider 706 may transmit the link at step 712 to the second user device. In some embodiments, the second user device may be a mobile phone associated with the first user device or user account making the request for services.

At 714, user device 704 may access the link configured and transmitted in 712, which may cause transmission of identification information to the user certificate system 302. In some embodiments, the user device 704 may access the link in response to user engagement with the link. In some embodiments, the user device 704 may access the link via a redirect or redirects, such as HTTP redirects. In some embodiments, in response to accessing the link at 714, the user device 704 may transmit identification information, comprising identity-linked information, to user certificate system 702. Alternatively or additionally, a third-party, such as, for example, a mobile carrier (not shown) may include information in the transmission to user certificate system 702, such as including identity-linked information in the transmission through header enrichment.

After receiving the identification information comprising at least the identity-linked information, at 716, the user certificate system 702 may retrieve certificate information, such as public certificate information comprising a public key, from a user certificate repository. In some embodiments, the user certificate system may query user certificate repository for public certificate information corresponding to the identity-linked information, and receive result data including the certificate information. In some embodiments, the certificate information retrieved may include public certificate information. In some embodiments, the certificate information may include user information, such as a name, birthday, and the like. Alternatively or additionally, in some embodiments, the certificate information retrieved may include a public key. In some embodiments, the certificate information retrieved may be in the form of a X.509 certificate.

At 718, the user certificate system 702 may retrieve a private key from a hardware security module. In some embodiments, the user certificate system may query the hardware security module for a private key corresponding to the identity-linked information, and receive result data including the private key. Alternatively or additionally, in some embodiments, the identification information received after step 714 may include a history or secret key, which may be used to identify and/or access the private key. For example, in some embodiments, a key included in the identification information may be used to decrypt the private key retrieved from querying the hardware security module.

At 720, the user certificate system 702 may notify user device 704 that information has been prepared on user certificate system 702 for use in generating an identity message. In some embodiments, user certificate system 702 may provide a response to a request transmitted to the user certificate system 702 in step 714. In some embodiments, the user certificate system 702 may transmit, to user device 704, information comprising a session ID.

At 722, the user device 704 may further notify service provider 706 that user certificate system 702 is prepared to transmit an identity message that is accessible based on a session ID. In some embodiments, for example, the user device 704 may receive information a response from the user certificate system 702 and transmit, to service provider 706, notification information indicative that user certificate system 702 is prepared to transmit an identity message accessible based on a session ID. In some embodiments, the user device 704 may provide additional information to the service provider 706. For example, in some embodiments, the user device 704 may transmit a session ID to the service provider 706. In such embodiments, for example, user device 704 may have generated the session ID before, during, or after a previous step. Additionally or alternatively, the user device 704 may have received the session ID from a third-party system before, during, or after a previous step. Alternatively or additionally, the user certificate system 702 may transmit the generated or received session ID to the user device, such as in step 720.

At 724, in response to receiving the notification information/request sent at 722, the service provider 706 may transmit, to user certificate system 702, a request for an identity message. In some embodiments, the request for the identity message may include a session ID generated by the service provider 706 or forwarded during a prior step, such as in the request for services at step 710 or the notification information received by the service provider 706 at step 722.

In response to receiving the request at step 724, the user certificate system 702 may, at 726, generate an identity message. Simultaneously or subsequently, at 728, the user certificate system 702 may encrypt a portion of the identity message. In some embodiments, the user certificate system may encrypt a portion of the identity message using the private key retrieved at step 718. Additionally or alternatively, the identity message may include, in either an encrypted or unencrypted portion, the identity-linked information, a time-stamp, the session ID, and/or further identifying or securing information. In such embodiments, including additional information in the identity message improves security by minimizing the risk of message intercept and subsequent reuse.

At 730, user certificate system 702 may transmit, to service provider 706, information including at least the identity message. In some embodiments, the information may further include a portion of the public certificate information retrieved from the user certificate repository at 716. For example, in some embodiments, the information may include at least a public key that may be used to decrypt an encrypted portion of the identity message. Alternatively or additionally, additional information transmitted in step 730 may be in the form of a digital certificate, such as a X.509 certificate.

At 732, service provider 706 may validate the received identity message. In some embodiments, the identity message may be validated by decrypting an encoded portion of the identity message using a corresponding public key. In some embodiments, the public key may be stored associated with a user account. Alternatively or additionally, in some embodiments, service provider 706 may receive the public key, such as at step 730, for subsequent use.

In some embodiments, at 734, the user certificate system may be further configured to generate a transaction report. In such embodiments, the transaction report may uniquely memorialize the transmission of the identity message to service provider 706. At 736, in some embodiments, the user certificate system 702 may be configured to store the transaction report generated in 734 in a ledger. In some embodiments, the ledger may be a blockchain associated with the user certificate system 702 such that the user certificate system 702 may append new transaction reports to the blockchain.

FIGS. 8, 9, and 10 illustrate an exemplary set of operations performed in accordance with an embodiment of the present invention. Specifically, each of the FIGS. 8, 9, and 10 illustrates an exemplary set of operations performed by one of user device 704, user certificate system 702, or service provider 706, such as an embodiment system functioning as shown in FIG. 1 and described in FIG. 7.

Turning now to FIG. 8, which illustrates a set of operations performed by a user certificate system, such as a user certificate system 702, in accordance with an exemplary embodiment of the present invention. At block 802, a user certificate system may receive, over a first network, identification information comprising at least identity-linked information. In some embodiments, the identity-linked information may include a phone number in plain-text, a phone number in hashed form, a device-linked identifier, a credit card number, or the like. In some embodiments, the identification information may comprise additional information useful for identifying the user or preparing data, such as a session ID, a name, or other user information/user identifying information, or the like.

In some exemplary embodiments, the user certificate system may receive information in block 802 over a first network that is out-of-band with respect to a second network between a user device and a service provider, which may enhance security. For example, in some embodiments, a user device may request, over a first network, services from a service provider and receive a link configured to transmit identification information from a user device to a user certificate system over a second network. Block 802 may occur in response to user interaction with the link on a user device, such as a mobile phone, configured to cause transmission of the identification information over a second network, such as a carrier network, that may be separate from a first network, such as the Internet, utilized to transmit a request from a user device to the service provider.

Having received the identity-linked information, the user certificate system, at block 804, may retrieve, from a user certificate repository, public certificate information linked to the identity-linked information. In some embodiments, the public certificate information may include at least a public key. Additionally or alternatively, the public certificate information may include additional information, such as identification information. In some embodiments, the user certificate system may retrieve the public certificate information from the user certificate repository by querying the user certificate repository for information linked with the identity-linked information and receiving result data.

At block 806, the user certificate system may retrieve, from a hardware security module, a private key. In an example embodiment, the private key may be stored in the hardware security module linked to the identity-linked information, such that the hardware security module may be queried, using the identity-linked information, for the corresponding private key.

In some embodiments, the user certificate system may use additional information, such as information received at block 802, to retrieve information from the user certificate repository and/or hardware security module. For example, in some embodiments, the identification information received may include a history key, such that the history key may be a secure key stored only on the user device after a previous authentication. In such embodiments, the user certificate system may decrypt the history key before use. Alternatively or additionally, the user certificate system may utilize the history key to identify and access public certificate information retrieved from the user certificate repository. A history key may be used when a first network, such as for transmitting information between a user device and a service provider, and a second network, such as for transmitting information to a user certificate system from a user device or carrier, are the same or shared, such as a single Wi-Fi network or similar means. In such embodiments, incorporating the history key as described may increase security of the system or method.

In some embodiments, the identification information received at block 802 may additionally include a secret key that may be used to decrypt the private key retrieved from the hardware security module. In such embodiments, the user device or service provider may store the secret key, and transmit it along with other information such that the user certificate system may receive it, for example as part of the identification information in block 802.

At 808, the user certificate system may cause transmission, to the service provider, of a notification indicative that an identity message is accessible based on a session ID. In some embodiments, the user certificate system may transmit information, such as response information, to a user device to cause the user device to transmit, from the user device to a service provider, the notification indicative that an identity message is accessible based on a session ID. In some embodiments, the user certificate system may be configured to generate the session ID or receive the session ID from a third-party system before, during, or after any of the blocks 802-806. In such embodiments, the user certificate system may transmit, to the user device, information including the session ID and cause the user device to forward, to the service provider, the information including the session ID.

At 810, the user certificate system may receive, from the service provider, a request for the identity message. In an example embodiment, the request may include the session ID.

At 812, in response to receiving the request for the identity message, the user certificate system may generate the identity message. In an example embodiment, simultaneously or subsequent to generating the identity message, the user certificate system may encrypt a portion of the identity message. In some embodiments, the user certificate system may encrypt a portion of the identity message using the private key retrieved at 806. Additionally or alternatively, the user certificate system may encrypt a portion of the identity message using the private key retrieved at 806 in conjunction with additional information, such as identification information received at 802. In some embodiments, the identification information received at 802 may include a secret key used to decrypt the private key before using the private key to encrypt the portion of the identity message. Alternatively or additionally, in some embodiments, the identification information received at 802 may include a private key fragment, such that the private key fragment may be combined with the private key retrieved at block 806 to form a complete private key. In such embodiments, the complete private key may then be used to encrypt a portion of the identity message.

The identity message may be empty or comprise a set of information. In some embodiments, the identity message may be empty. In some embodiments, the identity message may include a time-stamp, a session ID, identity-linked information, such as a telephone number in hashed or plain-text form, or the like. Including additional information in the identity message may enhance security by minimizing the risk of message intercept and subsequent reuse.

At block 814, the user certificate system transmits the identity message to the service provider. In some embodiments, the user certificate system may transmit the identity message and additional information. In some embodiments, for example, the user certificate system may transmit a portion of the public certificate information, such as a public key, to the service provider along with the identity message. In such embodiments, the service provider may use the public key to validate the identity message.

In some embodiments, at optional block 816, the user certificate system may generate a transaction report. The transaction report may memorialize the transmission of the identity message to the service provider. In some embodiments, at optional block 818, the user certificate system may store the transaction report generated in block 816 in a ledger. In some embodiments, the user certificate system may maintain a list, database, or other component associated with the user certificate system that facilitates storage of transaction reports. Alternatively, the user certificate system may be configured to store the transaction report in a blockchain associated with the user certificate system, or submit transaction reports to be stored in a blockchain.

Turning now to FIG. 9, which illustrates a set of operations performed by a user device, such as a user device 704, in accordance with an exemplary embodiment of the present invention.

At block 902, the user device transmits, to a service provider over a first network, a request for services. In some embodiments, the request for services may include a request to log in to a service offered by the service provider, access a service, such as to perform a high-value transaction, or the like. At block 904, the user device receives, from the service provider, a response comprising at least a link configured to transmit a request to the user certificate system upon accessing the link. In some embodiments, the response received at block 904 may additionally comprise a session ID generated by the service provider or received by the service provider from a third-party. In some embodiments, the response may be a SMS sent to a user device associated with the request for services made to the service provider in block 902. In some embodiments, the response may be a local device message, such as an operating system message or application message, displayed on a user device.

At block 906, the user device accesses the link provided at block 904. In some embodiments, the user device may be configured to access the link in response to user engagement with the link on the user device, a display associated with the user device, or the like. Additionally or alternatively, the user device may be configured to access the link automatically, for example by using a redirect or redirects, such as HTTP redirects.

At block 908, the user device transmits identification information to the user certificate system over a second network. In some embodiments, transmission of the identification information may cause the user certificate system to link certificate information to identity-linked information transmitted to the user certificate system. In some embodiments, the identification information may comprise identity-linked information. In some embodiments, the identification information may have identity-linked information included during the transmission by a third-party, such as a carrier using a process such as header enrichment. In some embodiments, the identification information may include a session ID, such as a session ID generated by the user device in an earlier step, such as blocks 902-906 as depicted in FIG. 9, received by the user device from a third-party system before beginning the steps depicted in FIG. 9, or received as part of the response from the service provider in block 904.

At block 910, the user device may receive, from the user certificate system, a response notification. In some embodiments, the response notification may be indicative that at least an identity message is accessible based on a session ID. In some embodiments, the session ID may have been transmitted to the user certificate system at block 908 as described above, alternatively or additionally, the session ID may be generated by the user certificate system and included in the response at block 910.

At block 912, in response to receiving the notification at block 910, the user device may transmit, to the service provider, a notification indicative that at least an identity message is accessible based on a session ID. In some embodiments, the user device may include the session ID as information transmitted as part the notification to the service provider, such that the service provider may later transmit the session ID to the user certificate system.

At block 914, the user device may cause the service provider to retrieve the identity message from the user certificate system. In some embodiments, block 914 may occur simultaneously with block 912, such that the transmission of the notification to the service provider causes the service provider to retrieve the identity message.

Turning now to FIG. 10, which illustrates a set of operations performed by a service provider, such as a service provider 706, in accordance with an exemplary embodiment of the present invention.

At block 1002, the service provider receives, over a first network, a request for services. In some embodiments, the request for services may comprise a request to log in to a service offered by the service provider, access a service, such as to perform a high-value transaction, or the like. In some embodiments, the request for services may be associated with a user account, such as a user account previously registered with the service provider.

At block 1004, the service provider may configure a link such that accessing the link on a user device may cause transmission of identification information from a user device to the user certificate system. In some embodiments, the link may be further configured such that accessing the link may cause a third-party to include information in a transmission of the user certificate system. For example, the link may be configured such that accessing the link on a user device causes a mobile carrier to include identity-linked information, such as a phone number, in the identification information transmitted to the user certificate system.

In some embodiments, the service provider may be configured to generate a session ID. Additionally or alternatively, in some embodiments, the service provider may be configured to receive a session ID from a third-party system. In such embodiments, the service provider may be configured to generate or receive the session ID during, before, or after any of the steps illustrated by blocks 1002 or 1004.

At block 1006, the service provider may transmit, to a user device, a response including the configured link. In some embodiments, the response may further include additional information, such as the session ID generated or received by the service provider. In some embodiments, the service provider may transmit the response at block 1006 to a second user device, such that the second user device is separate but associated with the user device that sent the request for services at block 1002. For example, in an exemplary embodiment, the service provider may be configured to receive the request for services from a first user device, determine a second device, for example a mobile device, associated with the first user device or the user account, and transmit the response at block 1006 to the second user device.

At block 1008, the service provider may receive, from a user device, information indicative that a portion of public certificate information is accessible on the user certificate system based on a session ID. In some embodiments, the information received at block 1008 may be notification information sent from the user device to the service provider after the user device transmitted identification information to the user certificate system via a second network, such as in block 912 in FIG. 9.

At block 1010, the service provider may transmit to the user certificate system, an identity message request. In some embodiments, the request transmitted at block 1010 may comprise additional information, such as a session ID.

At block 1012, the service provider may receive, from the user certificate system, response information including the identity message. In some embodiments, the response information may also include additional information, such as public certificate information, such as a public key, for use in validating the identity message.

At block 1014, the service provider may validate the identity message. In an example embodiment, the identity message may include an encrypted portion. In some embodiments, the service provider may retrieve a stored public key associated with the user account that may be used to decrypt the encrypted portion of the identity message. A service provider may have stored a public key associated with a user account, such as through a registration process as described herein, for example the registration process illustrated in FIG. 3. Alternatively or additionally, the service provider may utilize the public certificate information received at block 1012, such as a public certificate including a public key, to decrypt the identity message. By successfully decrypting the identity message, the service provider may have consider the identity message validated. Accordingly, the service profile may be certain that the user that submitted the request for services is who they claim to be based on the certainty of identity-linked information as a proxy for user identity.

In some embodiments, while a single user certificate may be used to provide identity authentication to multiple service providers, a user certificate system may be configured to support multiple certificates for a given user. In some embodiments, a user certificate system may be configured to store a single certificate for each service provider. In such embodiments, the user certificate system may receive service provider identification information for use in storing the certificate information, such as during a registration process depicted by FIG. 3, or for use in retrieving the certificate information, such as a public and private key, during an identification process, such as during the identification process depicted by FIG. 7.

In one example embodiment, a dedicated credit card certificate may be registered and linked with identity-linked information such as a user's mobile phone number, credit card account number, or the like, using the registration process depicted in FIG. 3 and further illustrated in FIGS. 4, 5, and 6. Accordingly, the credit card certificate be utilized to perform identity authentication, using the identity authentication process depicted in FIG. 7 and further illustrated in FIGS. 8, 9, and 10, when a user requests services such as an online payment transaction with a given credit card. An exemplary system may verify a user identity, using an identity message, to a credit card issuer or other capable entity, and initiate payment.

As will be appreciated by one of ordinary skill in the art, information request and transmission steps illustrated by steps in the data flow diagrams depicted by FIGS. 3 and 7, and block(s) in flowcharts depicted by FIGS. 4, 5, 6, 8, 9, 10, and 12 may be typically be performed, in an exemplary embodiment, over HTTPs connections between devices on a network. However, as will be appreciated, such steps or block(s) may be performed over HTTP. If HTTP is used to transmit the identity-linked information to a user certificate system, the transmission should be secured using alternative means, such as a private VPN or other secured means, so as to prevent vulnerability to a cyber-attack. In an exemplary embodiment, all information requests and information transmissions would occur over secure means.

As will be appreciated by one of ordinary skill in the art, the certificate-based identity message identification authentication process illustrated in FIGS. 7, 8, 9, and 10 may be used as a second-factor authentication method. Alternatively, the certificate-based identity message identification authentication process may be used in lieu of credentials. In such embodiments, possession of the user device should be confirmed using a device possession confirmation event prior to identity authentication through an identity message.

### Alternative System Architecture

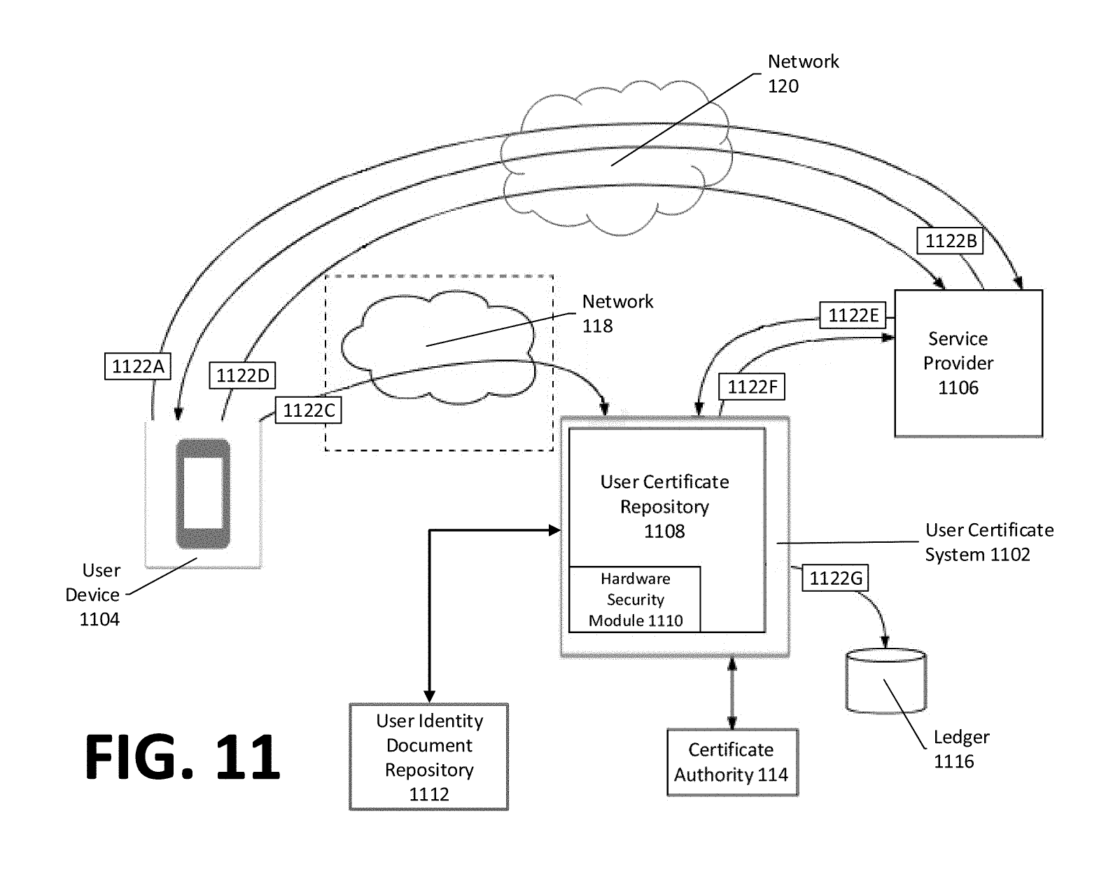

FIG. 11 illustrates an alternative system in accordance with another embodiment of the present invention. The system illustrated in FIG. 11 includes a user device 1104, a user certificate system 1102, and a service provider 1106. Additionally, user certificate system 1102 is associated with a user identity document repository 1112. Similarly named components may operate substantially or entirely as described above in regards to FIG. 1.

User identity document repository 1112 may be configured to store, manage, and/or release documents to a third-party, such as service provider 1106. For example, in some embodiments, the user certificate system 1102 may be configured to retrieve an identity verification document from user identity document repository 1112 and release it for identity purposes to service provider 1106. In some embodiments, user identity document repository 1112 may be a sub-module of user certificate system 1102. In some embodiments, user identity document repository 1112 may be system, hardware component, or device configured to communicate with user certificate system 1102. In some embodiments, the user certificate system 1102 may be configured to access the user identity document repository 1112 to store, manage, and release identity verification documents.

In some embodiments, access to a user identity document repository 1112 that is distinct from the user certificate system 1102 may occur after authentication with an identity message. In some embodiments, access to the user identity document repository 1112 that is distinct, or separate, from the user certificate system 1102 occurs following an alternative identity event or device possession event. For example, in some embodiments, access to a user identity document repository 1112 occurs following engagement by user device 1104 with a third-party device or service provider device, for example, by a near field communication (“NFC”) chip associated with the user device 1104 following engagement of the user device with a transaction terminal associated with a third-party entity or service provider. In some embodiments, access to a user identity document repository 1112 occurs following a device possession event that involves proximity of the user device to a particular location, for example, by determining user device 1104 is within a particular proximity to a particular location. In some embodiments, device possession events involving proximity are determined by the user device 1104, service provider 1106 or an associated system, network carrier system, localized beacon (such as a Bluetooth or similar beacon), or the like. In such an embodiment, the user identity document repository 1112 may be considered a second service provider that may provide services to a user to access their identity verification documents in the user identity document repository for addition, deletion, and distribution of the identity verification documents to third-parties or other service providers.

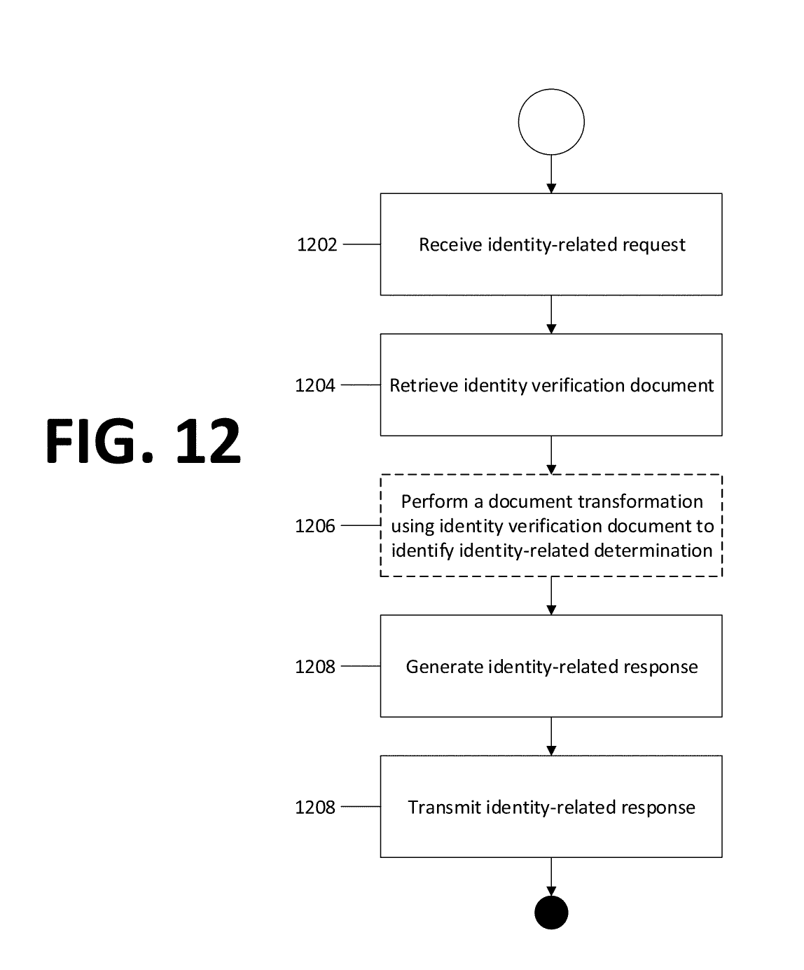

FIG. 12 illustrates an example flowchart of operations to be performed by a user identity document repository in accordance with embodiments of the present disclosure. In some embodiments, the operations depicted in FIG. 12 are performed by a user certificate system including an identity document repository module, for example apparatus 200 including user identity document repository module 214 as illustrated in FIG. 2 and described above. Alternatively, in some embodiments, some operations depicted in FIG. 12 are performed by a user identity document repository separate from a user certificate system, for example user identity document repository 1112 as illustrated in FIG. 11 and described above. In some embodiments, the separate user identity document repository is associated with the user certificate system, and thus utilized to store, retrieve, or otherwise access identity verification documents. In some embodiments, the operations illustrated in FIG. 12 are performed after a distinct user identity document repository is authenticated, such as via a device possession event, identity event, or an identity message as described above.

In the depicted flowchart, at block 1202, an identity-related request is received. In some embodiments, the identity-related request includes identity-linked information. Received identity-linked information may be used to identify identification verification documents, which may include information useful in identifying an identity-related determination to answer the identity-related request. For example, a particular identity-related request may represent an age check requesting to know if a certain user is above a specified age. In this example, additionally or alternatively, the identity-related request may include identifier information, such as identity-linked information, for use in obtaining an identity verification document. For example, an identification card image that includes a birthdate may be stored in a user identity document repository associated with identity-linked information or another identifier, which may be included in the identity-linked request. Additionally or alternatively, in an example embodiment, the received identity-related request may also include additional limits or parameters useful in identifying an identity-related determination. For example, an exemplary identity-related request may include threshold information associated with the identity-related request. In the age check example described above, the threshold information may represent a specified age that the user should be over for an affirmative identity-related determination to be identified. Additional limits or parameters, such as threshold information, may be determined by a service provider or third-party, or by a user certificate system, or by the user identity document repository or a related module.

In some embodiments, an identity-related request requires that a requesting entity, such as a service provider or third party, be authenticated via a successful identity event or a device possession event. For example, in some embodiments, an identity-related request is received from a service provider after authentication via an identity message, as described above. In some embodiments, an identity-related request is received from a service provider after authentication via a NFC tap of a user device against a transaction terminal. In some embodiments, an identity-related request is received from a service provider after a user device is identified as within a proximity to a particular location, for example as determined by a network, system, user device, or beacon device (e.g., a Bluetooth™ beacon).

At block 1204, an identity verification document is retrieved. For example, in an example embodiment, a user identity document repository utilizes identity-linked information in the identity-related request to identify and retrieve documents corresponding to the user in question. For example, an identification card may be retrieved at block 1204 for use in the aforementioned age check example. In some embodiments, for example where a user certificate system is associated with a separate user identity document repository, block 1204 is achieved by transmitting a request for identity verification documents to the separate user identity document repository, and receiving the identity verification documents as part of a response.

At optional block 1206, a document transformation is performed using the identity verification document or documents retrieved at block 1204. For example, a document transformation may be performed using an identity verification document, or a particular identity verification document in an identity verification document set, to identify an identity-related determination. Returning to the age check example, a particular document transformation may be performed on an identification card, or identification card image, to identify birthdate information and process the birthdate information to identify an identity-related determination. For example, if a retrieved identity verification document, such as an identification card, indicates a user was born in the year 1980, this birthdate information would be identified and/or extracted, and processed to identify an affirmative identity-related determination in response to an age check with a specified age of 21.

At block 1208, an identity-related response is generated. In some embodiments, an identity-related response includes an identity-related determination, for example an identity-related determination identified via the document transformation at optional lock 1206. Alternatively or additionally, in some embodiments, an identity-related response includes the identity verification document, or a portion of the identity verification document, retrieved at block 1204. The identity verification document, or portion thereof, may include identification information useful in answering the identity-related request.

Alternatively, in some embodiments, an identity-related request is a request for an identity verification document, or portion thereof, rather than a request for an identity-related determination. Accordingly, in response to such requests, some example embodiments may transmit an identity-related response including the identity verification documents, or identity verification documents, retrieved at block 1204 as described above. Alternatively or additionally, in some embodiments, an identity-related response includes a portion of the identity verification document retrieved at block 1204.

At block 1210, the identity-related response is transmitted. In some embodiments, the identity-related response is transmitted directly to a service provider, or third-party, in response to a received identity-related request.

In some embodiments, a user certificate system, or modules therein, performs operations 1202, 1206, 1208, and 1210, and causes a separate user identity document repository performs operation 1204. In such embodiments, the user certificate system may communicate with the separate user identity document repository and receive the retrieved identity verification document from the user identity document repository.

FIGS. 4, 5, 6, 8, 9, 10, and 12 illustrate example flowchart of the example operations performed by a method, apparatus, and computer program product in accordance with an embodiment of the present invention. It will be understood that each block of the flowcharts, and combinations of blocks in the flowcharts, may be implemented by various means, such as hardware, firmware, processor, circuitry, and/or other devices associated with execution of software including one or more computer program instructions.

For example, in reference to FIGS. 4, 5, 6, 8, 9, 10, and 12, one or more of the procedures described herein may be embodied by computer program instructions. In this regard, the computer program instructions which embody the procedures described above may be stored by a memory 204 of an apparatus employing an embodiment of the present invention and executed by a processor 202 in the apparatus.

As will be appreciated by one of ordinary skill in the art, any such computer program instructions may be loaded onto a computer or other programmable apparatus (e.g., hardware) to produce a machine, such that the resulting computer or other programmable apparatus provides for implementation of the functions specified in the block(s) of the corresponding flowchart. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the block(s) of the flowchart. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the block(s) of the flowchart. As such, the operations of FIGS. 4, 5, 6, 8, 9, 10, and 12 when executed, convert a computer or processing circuitry into a particular machine configured to perform an example embodiment of the present invention. Accordingly, the operations of FIGS. 4, 5, 6, 8, 9, 10, and 12 define an algorithm for configuring a computer or processing circuitry to perform an example embodiment.

Accordingly, blocks of the flowchart support combinations of means for performing the specified functions and combinations of operations for performing the specified functions. It will also be understood that one or more blocks of the flowchart, and combination of blocks in the flowchart, can be implemented by special-purpose hardware-based computer systems which perform the specified functions, or combinations of special purpose hardware and computer instructions.

In some embodiments, certain ones of the operations herein may be modified or further amplified as described below. Moreover, in some embodiments, additional optional operations may also be included. It should be appreciated that each of the modifications, optional additions, or amplifications below may be included with the operations above either alone or in combination with any others among the features described herein.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of processing an identity-related request on a user certificate system associated with a user identity document repository, the method comprising:
receiving, from a requesting entity, an identity-related request;
retrieving an identity verification document set associated with the identity-related request from a user identity document repository;
generating an identity-related response using the retrieved identity verification document set; and
transmitting the identity-related response to the requesting entity.

2. The method of claim 1, wherein the identity-related request comprises identifier information, and wherein retrieving the identity verification document set comprises:
querying the user identity document repository for the identity verification document set associated using the identifier information; and
receiving a response comprising the identity verification document set.

3. The method of claim 1, wherein retrieving the identity verification document set comprises:
receiving, over a first network, identification information comprising at least identity-linked information;
querying the user identity document repository for the identity verification document set associated using the received identity-linked information; and
receiving a response comprising the identity verification document set.

4. The method of claim 1 further comprising:
receiving, over a first network, identification information comprising at least identity-linked information;
retrieving certificate information associated with identity-linked information;
generating an identity message using the retrieved certificate information; and
transmitting, to the requesting entity over a second network, the identity message.

5. The method of claim 1, wherein the generated identity-related response comprises the retrieved identity verification document set.

6. The method of claim 1, wherein the generated identity-related response comprises a portion of a particular identity verification document in the identity verification document set.

7. The method of claim 1, wherein generating the identity-related response using the retrieved identity verification document set comprises:
performing a document transformation using a particular identity verification document in the identity verification document set;
identifying an identity-related determination; and
generating the identity-related response comprising the identity-related determination.

8. The method of claim 1, wherein the identity-related request is a request to combine a first identity verification document associated with first identifier information and second identity verification document associated with second identifier information, and wherein retrieving the identity document set comprises:
retrieving the first identity verification document using the first identifier information; and
retrieving the second identity verification document using the second identifier information,
wherein the method further comprises:
combining the first identity verification document and the second identity verification document to form a combined verification document; and
storing the combined verification document in the user identity document repository,
wherein the generated identity-related response comprises information indicating successful formation of the combined verification document.

9. The method of claim 1, wherein the identity-related request is a request to cross-check a first identity verification document associated with first identifier information and second identity verification document associated with second identifier information, and wherein retrieving the identity document set comprises:
retrieving the first identity verification document using the first identifier information; and
retrieving the second identity verification document using the second identifier information,
wherein the method further comprises:
extracting first identification information in the first identity verification document;
extracting second identification information in the second identity verification document; and
comparing the first identification information with the second identification information to identify an identity-related determination,
wherein the generated identity-related response comprises the identity-related determination.

10. The method of claim 1, wherein the identity-related request is a request to score a first identity verification document associated with first identifier information and second identity verification document associated with second identifier information, and wherein retrieving the identity document set comprises:
retrieving the first identity verification document using the first identifier information; and
retrieving the second identity verification document using the second identifier information,
wherein the method further comprises:
identifying scoring rules associated with the identity-related request;
generating, using the scoring rules, a first document score associated with the first identity verification document;
generating, using the scoring rules, a second document score associated with the second identity verification document; and
identifying an identity-related determination using the first document score and the second document score,
wherein the generated identity-related response comprises the identity-related determination.

11. An apparatus configured to process an identity-related request on a user certificate system associated with a user identity document repository, the apparatus comprising at least a processor and a memory associated with the processor having computer coded instructions therein, with the computer coded instructions configured to, when executed by the processor, cause the apparatus to:
receive, from a requesting entity, an identity-related request;
retrieve an identity verification document set associated with the identity-related request from a user identity document repository;
generate an identity-related response using the retrieved identity verification document set; and
transmit the identity-related response to the requesting entity.

12. The apparatus of claim 11, wherein the identity-related request comprises identifier information, and wherein the computer program instructions configured to cause the apparatus to retrieve the identity verification document set comprise computer program instructions configured to, when executed by the processor, cause the apparatus to:
query the user identity document repository for the identity verification document set associated using the identifier information; and
receive a response comprising the identity verification document set.

13. The apparatus of claim 11, wherein the computer program instructions configured to cause the apparatus to retrieve the identity verification document comprises computer program instructions configured to, when executed by the processor, cause the apparatus to:
receive, over a first network, identification information comprising at least identity-linked information;
query the user identity document repository for the identity verification document set associated using the received identity-linked information; and
receive a response comprising the identity verification document set.

14. The apparatus of claim 11, wherein the memory further comprises computer program instructions configured to, when executed by the processor, cause the apparatus to:
receive, over a first network, identification information comprising at least identity-linked information;
retrieve certificate information associated with identity-linked information;
generate an identity message using the retrieved certificate information; and
transmit, to the requesting entity over a second network, the identity message.

15. The apparatus of claim 11, wherein the generated identity-related response comprises the retrieved identity verification document set.

16. The apparatus of claim 11, wherein the generated identity-related response comprises a portion of a particular identity verification document in the identity verification document set.

17. The apparatus of claim 11, wherein the computer coded instructions configured to cause the apparatus to generate the identity-related response using the retrieved identity verification document set comprises computer coded instructions configured to, when executed by the processor, cause the apparatus to:
perform a document transformation using a particular identity verification document in the identity verification document set;
identify an identity-related determination; and
generate the identity-related response comprising the identity-related determination.

18. The apparatus of claim 11, wherein the identity-related request is a request to combine a first identity verification document associated with first identifier information and second identity verification document associated with second identifier information, and wherein the computer coded instructions configured to cause the apparatus to retrieve the identity document set comprises computer coded instructions configured to, when executed by the processor, cause the apparatus to:
retrieve the first identity verification document using the first identifier information; and
retrieve the second identity verification document using the second identifier information,
wherein the memory further comprises computer coded instructions configured to, when executed by the processor, cause the apparatus to:
combine the first identity verification document and the second identity verification document to form a combined verification document; and
store the combined verification document in the user identity document repository,
wherein the generated identity-related response comprises information indicating successful formation of the combined verification document.

19. The apparatus of claim 11, wherein the identity-related request is a request to cross-check a first identity verification document associated with first identifier information and second identity verification document associated with second identifier information, and wherein the computer coded instructions configured to, when executed by the processor, cause the apparatus to retrieve the identity document set comprises computer coded instructions that, when executed by the processor, cause the apparatus to:
retrieve the first identity verification document using the first identifier information; and
retrieve the second identity verification document using the second identifier information,
wherein the memory further comprises computer coded instructions configured to, when executed by the processor, cause the apparatus to:
extract first identification information in the first identity verification document;
extract second identification information in the second identity verification document; and
compare the first identification information with the second identification information to identify an identity-related determination,
wherein the generated identity-related response comprises the identity-related determination.

20. The apparatus of claim 11, wherein the identity-related request is a request to score a first identity verification document associated with first identifier information and second identity verification document associated with second identifier information, and wherein the computer coded instructions configured to, when executed by the processor, cause the apparatus to retrieve the identity document set comprises computer coded instructions that, when executed by the processor, cause the apparatus to:
retrieve the first identity verification document using the first identifier information; and
retrieve the second identity verification document using the second identifier information,
wherein the memory further comprises computer coded instructions configured to, when executed by the processor, cause the apparatus to:
identify scoring rules associated with the identity-related request;
generate, using the scoring rules, a first document score associated with the first identity verification document;
generate, using the scoring rules, a second document score associated with the second identity verification document; and
identify an identity-related determination using the first document score and the second document score,
wherein the generated identity-related response comprises the identity-related determination.

21. A computer program product for processing an identity-related request on a user certificate system associated with a user identity document repository, the computer program product comprising at least one non-transitory computer-readable storage medium having computer executable program code instructions stored therein, the computer-executable program code instructions comprising program code instructions for:
receiving, from a requesting entity, an identity-related request;
retrieving an identity verification document set associated with the identity-related request from a user identity document repository;
generating an identity-related response using the retrieved identity verification document set; and
transmitting the identity-related response to the requesting entity.

22. The computer program product of claim 21, wherein the identity-related request comprises identifier information, and wherein the program code instructions for retrieving the identity verification document set comprises computer program instructions for:
querying the user identity document repository for the identity verification document set associated using the identifier information; and
receiving a response comprising the identity verification document set.

23. The computer program product of claim 21, wherein the program code instructions for retrieving the identity verification document set comprises program code instructions for:
receiving, over a first network, identification information comprising at least identity-linked information;
querying the user identity document repository for the identity verification document set associated using the received identity-linked information; and
receiving a response comprising the identity verification document set.

24. The computer program product of claim 21, further comprising program code instructions for:
receiving, over a first network, identification information comprising at least identity-linked information;
retrieving certificate information associated with identity-linked information;
generating an identity message using the retrieved certificate information; and
transmitting, to the requesting entity over a second network, the identity message.

25. The computer program product of claim 21, wherein the generated identity-related response comprises the retrieved identity verification document set.

26. The computer program product of claim 21, wherein the generated identity-related response comprises a portion of a particular identity verification document in the identity verification document set.

27. The computer program product of claim 21, wherein the program code instructions for generating the identity-related response using the retrieved identity verification document set comprises program code instructions for:
performing a document transformation using a particular identity verification document in the identity verification document set;
identifying an identity-related determination; and
generating the identity-related response comprising the identity-related determination.

28. The computer program product of claim 21, wherein the identity-related request is a request to combine a first identity verification document associated with first identifier information and second identity verification document associated with second identifier information, and wherein the program code instructions for retrieving the identity document set comprises program code instructions for:
retrieving the first identity verification document using the first identifier information; and
retrieving the second identity verification document using the second identifier information,
wherein the computer program product further comprises program code instructions for:
combining the first identity verification document and the second identity verification document to form a combined verification document; and
storing the combined verification document in the user identity document repository,
wherein the generated identity-related response comprises information indicating successful formation of the combined verification document.

29. The computer program product of claim 21, wherein the identity-related request is a request to cross-check a first identity verification document associated with first identifier information and second identity verification document associated with second identifier information, and wherein the program code instructions for retrieving the identity document set comprises program code instructions for:
retrieving the first identity verification document using the first identifier information; and
retrieving the second identity verification document using the second identifier information,
wherein the computer program product further comprises program code instructions for:
extracting first identification information in the first identity verification document;
extracting second identification information in the second identity verification document; and
comparing the first identification information with the second identification information to identify an identity-related determination,
wherein the generated identity-related response comprises the identity-related determination.

30. The computer program product of claim 21, wherein the identity-related request is a request to score a first identity verification document associated with first identifier information and second identity verification document associated with second identifier information, and wherein the program code instructions for retrieving the identity document set comprises program code instructions for:
retrieving the first identity verification document using the first identifier information; and
retrieving the second identity verification document using the second identifier information,
wherein the computer program product further comprises program code instructions for:
identifying scoring rules associated with the identity-related request;
generating, using the scoring rules, a first document score associated with the first identity verification document;
generating, using the scoring rules, a second document score associated with the second identity verification document; and
identifying an identity-related determination using the first document score and the second document score,
wherein the generated identity-related response comprises the identity-related determination.
